(19) United States
(12) Patent Application Publication
(10) Pub. No.: US 2012/0303412 A1
(43) Pub. Date: Nov. 29, 2012

(54) PRICE AND MODEL PREDICTION SYSTEM AND METHOD

(76) Inventors: Oren Etzioni, Seattle, WA (US); David Hsu, Atlanta, GA (US); Igor Tartarinov, Shoreline, WA (US)

(21) Appl. No.: 13/303,084

(22) Filed: Nov. 22, 2011

Related U.S. Application Data
(60) Provisional application No. 61/417,159, filed on Nov. 24, 2010.

(51) Int. Cl. G06Q 30/02

(52) U.S. Cl. 705/7.31

(57) ABSTRACT

Data relating to products sold across a plurality of merchants may be gathered from a variety of sources and processed, including with machine learning components. Identifiers of a same product sold by different merchants may be de-duplicated and/or matched as part of the data processing into a smaller set of uniquely identified products. When the data comes from text, including free-form text, an information extraction and/or machine learning component may be used to detect references to new and known unique products, including product successors (e.g., new product models). Product successor availability may be determined based on gathered data. Product price movement direction predictions, and/or product price range predictions may be determined, as well as purchase-timing recommendations (e.g. Buy or Wait). Such recommendations may be provided for presentation (e.g., to prediction service users) in a variety of forms.

### CROSS-REFERENCES TO RELATED APPLICATIONS

This application claims the benefit of U.S. Provisional Application No. 61/417,159, filed Nov. 24, 2010, titled “PRICE AND MODEL PREDICTION SYSTEM AND METHOD,” the contents of which is hereby incorporated in its entirety by reference

### FIELD OF THE INVENTION

This invention pertains generally to information processing and, more particularly, to decision support.

### BACKGROUND

Customers shopping for a product want to obtain the “right” product at the best price for that product. Often, there is a tradeoff between the quality of the product and its price. For example, one can buy a laptop with a faster CPU and more memory at a higher price.

The exact timing of the purchase can strongly influence this tradeoff. By buying a product “at the right time”, the customer can obtain a better price. In many cases, postponing a purchase enables a customer to obtain a discount. In other cases, new products become available. This is particularly common for technology-based products (e.g., laptops, TVs, software, games, and more) where new and improved products are released over time, and older products are discounted. Thus, postponing a purchase sets up another tradeoff: postponing can lead to a better price, a better product (or both), but the customer cannot make use of the product while waiting to purchase it.

These tradeoffs hold whether the customers are private individuals, groups of individuals, corporations, or government agencies. Moreover, the goal of obtaining the best price holds whether the product is a consumer good, a service, a commodity, an information good, or any other purchased item. Finally, the goal holds whether customers are shopping online, in a physical store, or in combination through a mobile device such as a mobile phone, or another kind of device that provides them with access to relevant information.

Comparison shopping engines, including shopping.com, Google's product search, and many others, guide customers on where to buy a product, but do not guide a customer on when to buy the product. The engines provide information about the current price, but they do not offer any prediction or other indication of where the price will go in the future. Yet prices for numerous goods are highly volatile.

Some conventional systems and methods provide predictions about future prices, but each is flawed. For example, some conventional systems and methods provide predictions with respect to airline ticket prices. However, such systems and methods are limited in scope and difficult to efficiently and/or effectively apply beyond the idiosyncratic airline ticket market. Some reasons why an e-commerce space can be different from, for example, a travel market include: (1) the e-commerce space may have a multitude of merchants offering the same product under different names and using terminology that can make it difficult to track the actual price of a product across sellers, (2) lack of a well-defined (e.g., standardized) way to partition products into sensible categories since each merchant can support a different categorization hierarchy, and (3) the presence of factors that make product pricing different for different people merely based on location (e.g. sales tax, shipping cost, local merchant prices). Some conventional systems and methods provide price history information, and even a “price alert”, which notifies a customer after a price drops, but they do not efficiently and/or effectively predict, anticipate, or advise customers about what will happen to prices in the future.

Some conventional systems and methods address price predictions for consumer products in a limited way. However, each has its flaws. For example, some fail to address the problem of matching products associated with non-standard identifiers, names and/or descriptions, particularly across multiple merchants and supply chain layers. Some fail to address categorization heterogeneity or geographically-based pricing. Some make predictions at too coarse a granularity, that react too slowly, that fail to take into account significant shorter term influences, and/or that can otherwise contribute to inefficient and/or ineffective purchase decisions.

Another field that is rife with speculation about future prices is the stock market. Brokers and other pundits claim to know how prices will move, and even set price targets for various stocks, and other financial indices or metrics (e.g., the rate of inflation). However, they do not make predictions for non-financial products that consumers may wish to purchase, such as laptops, televisions, cameras, and the like.

Price volatility can be significant across a wide range of product categories. However, price volatility isn't the only source of uncertainty for customers. As mentioned above, another consideration is identifying what product to purchase and, in particular, the tradeoff between the timing of purchase and the particular item purchased. For instance, if a consumer purchases a particular iPhone, he or she risks missing out on features of a new and improved iPhone that may be introduced the next week or the next month.

Some conventional systems and methods provide information about projected release dates of replacement products based on historical product information. However, such conventional systems and methods have prediction quality flaws. For example, naïve trending based on historical product information can be inaccurate to an extent that significantly lowers a value of the predictions. Some conventional approaches fail to take into account the economic ecosystem in the context of which a product is created and sold. For example, competitive dynamics, including price competition, occurring at one or more layers of a product delivery chain can significantly influence future prices. Some conventional approaches lack an ability to detect one or more types of information capable of improving prediction accuracy. Some conventional approaches lack an ability to suitably react to such information. Some conventional approaches employ highly paid human analysts to generate high quality predictions, but such approaches can be problematic with respect to consistency, cost and/or scalability.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

Data such as product specifications, pricing, reviews, and titles may be gathered from multiple merchants with respect to a set of products, for example, directly or through intermediate sources. Data may be collected and normalized, for example, so that relevant information about products from one or more merchants can be correctly associated.

Data, including free-form text, may be gathered from a variety of sources and processed, including with machine learning and text extraction components, to detect pricing trends across multiple merchants, references to new and known products, including product successors (e.g., new product models), and information about the products including product specifications and information related to pricing and availability during future time intervals.

Purchase timing recommendations with respect to future product prices may be determined based on gathered data where data corresponding to individual products is aggregated and normalized across relevant merchants, and/or based on extracted information about future prices from text sources that is associated with existing or new products. Product successor availability may also be taken into account. Such purchase timing recommendations can take a variety of forms including a specific timely recommendation (e.g., “buy” versus “wait”), predicted price movement direction, and predicted future price ranges, and be provided for presentation in a variety of forms.

### BRIEF DESCRIPTION OF THE DRAWINGS

Illustrative embodiments of the present invention are described in detail below with reference to the following drawing figures:

FIG. 1 is a schematic diagram depicting aspects of an example computing environment in accordance with at least one embodiment of the invention;

FIG. 2 is a schematic diagram depicting aspects of an example prediction service in accordance with at least one embodiment of the invention;

FIG. 3 is a schematic diagram depicting aspects of an example decision support component in accordance with at least one embodiment of the invention;

FIG. 4 is a procedural flowchart depicting example steps for price and model prediction in accordance with at least one embodiment of the invention;

FIG. 5 is a procedural flowchart depicting further example steps for price and model prediction in accordance with at least one embodiment of the invention;

FIG. 6 is a procedural flowchart depicting still further example steps for price and model prediction in accordance with at least one embodiment of the invention; and

FIG. 7 is a schematic diagram depicting aspects of an example computer in accordance with some embodiments of the present invention.

Note that the same numbers are used throughout the disclosure and figures to reference like components and features.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

In accordance with at least one embodiment of the invention, a datamining system allows combination of information about existing products with news stories, blog posts, press releases and other free-form text sources that speculate or even announce events or information about future products. Relevant information about the future may be exposed as it pertains to products that customers are shopping for today. In e-commerce, different merchants may use different terminology to talk about the same product. In accordance with at least one embodiment of the invention, a situation in which two product offers by different merchants actually refer to the same underlying product may be detected. For example, such detections may be based on an analysis of UPC/EAN codes and/or normalized brand names and model numbers that can be inferred from supplied MPN numbers and free-form text.

In accordance with at least one embodiment of the invention, free-form text such as news stories, blog posts, product announcements and the like may be associated with existing products. Such associations can be broad matches (e.g., the product and text are both associated with a same category and/or brand such as apple laptops), to relatively narrow (e.g., the text mentions a potential successor to the Nikon D90 camera). In accordance with at least one embodiment of the invention, such associations are based on an ability to categorize text into a same set of categories in which products are organized, and/or an ability to extract potential brand, technical specifications, model names, and/or family lines from free-form text and associate them with products.

In accordance with at least one embodiment of the invention, relevant product information may be extracted from free-form text. For example, extracted information may include technical specifications, potential release dates, and potential pricing information.

In accordance with at least one embodiment of the invention, product price movements may be predicted and may be adapted for the challenges of e-commerce. For example, the same product offered by different merchants may be matched together so that predictions on an aggregate price (e.g., an average price or a minimum price) for a product across a set of merchants can be determined. In many product categories, there may not be a predefined set of product types that is consistent across merchants. In accordance with at least one embodiment of the invention, products may be categorized into a hierarchy, for example, corresponding to similar behavior by products. Different customers may pay different amounts for the same product at the same time simply based on the customer's location due to location-specific costs such as sales tax and shipping costs. In accordance with at least one embodiment of the invention, such location specific modifications to prices may be taken into account when making location specific price predictions.

In accordance with at least one embodiment of the invention, extraction of information from free-form text and product matching may be utilized as part of (1) forecasting information about potential not-yet-released products and (2) associating such forecasts with relevant products that are or have been available for purchase in the past. Accordingly, such forecasts may be based on data gleaned from free-form textual data sources such as news stories, blog posts and product announcements. Information that may be inferred from such textual data sources includes: pricing information about a product in the future, technical specifications about future products, as well as potential and/or actual release dates and/or time periods. In addition, announcements about future pricing for currently available products may be identified and taken into account enhance price prediction accuracy.

In accordance with at least one embodiment of the invention, purchase timing recommendations may be determined based on price predictions for existing products, and various levels of detail about future price movements may be presented to support the recommendations. Purchase timing recommendations may be augmented based on pricing forecasts that incorporate information extracted from free-form text and product matching. Alternatively, or in addition, purchase timing recommendations for existing products may be based on release date predictions for potential successors, for example, as determined based on information extracted from free-form text. In accordance with at least one embodiment of the invention, purchase timing recommendations may be enhanced (e.g., with respect to accuracy) based on product release data including predictions of future release dates.

In various embodiments, to at least partially address problems such as those discussed above, systems and methods such as those described below may be used to predict future prices of products, predict release dates for product successors, and/or provide product purchase timing recommendations that can benefit product buyers. Purchase timing recommendations may take into account price predictions and/or successor availability information. For example, price predictions may take into account successor availability information. Significantly, product price predictions and/or product successor availability predictions in accordance with at least one embodiment of the invention may take into account information drawn from a wide variety of sources including free-form text (i.e., text not explicitly structured to facilitate computer parsing such as sentences of a natural language) from data feeds such as web sites. Accordingly, product pre-announcements, rumors, data from suppliers and distributors, and the like can also play a role in these predictions.

In accordance with at least one embodiment of the invention, predicting product successor availability may include constructing a lineage for the product that corresponds to a path through ancestors (and possibly descendants) of the product representing a logical evolution of the product over time from a consumer's point of view. Such product lineages may be constructed independent of officially designated product successors or even of particular product manufacturers and/or brands. Such product lineages can enhance a relevance, as well as an accuracy, of a successor availability prediction.

In accordance with at least one embodiment of the invention, purchase timing recommendations may have a variety of forms of increasing sophistication and complexity. For example, in accordance with a first form, a purchase timing recommendation may be one of a recommendation to buy now and a recommendation to wait until later. Purchase timing recommendations may include an indication of a predicted price movement. For example, price movement indicators may be selected from one of: up, down and flat. Price movement indicators may be included and/or be accompanied by an indication of movement direction confidence and/or an indication of movement magnitude (e.g., a predicted range of prices). A purchase timing recommendation may further include one or more explanations corresponding to one or more most significant factors contributing to the purchase timing recommendation.

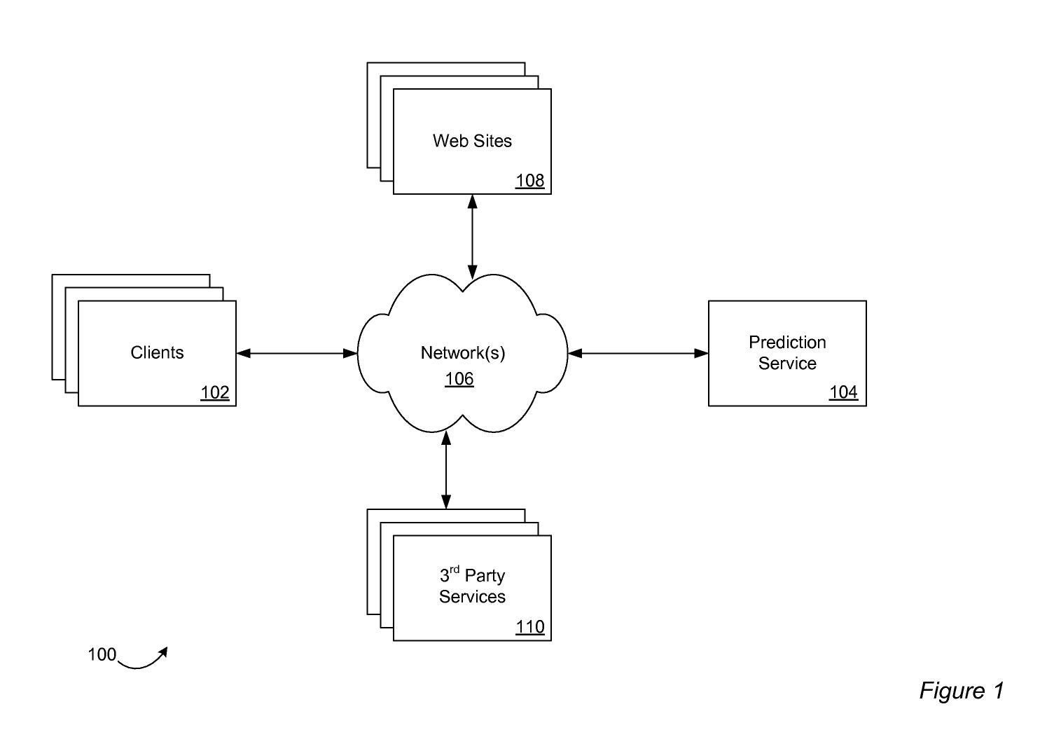

Various embodiments may be implemented, at least in part, with one or more computing devices and/or computing device components. FIG. 1 depicts aspects of an example computing environment 100 in accordance with at least one embodiment of the invention. The example computing environment 100 includes clients 102 capable of accessing a prediction service 104 through one or more networks 106. For example, the network(s) 106 may include a communication network and/or a computer network. The network(s) 106 may include a telephony network and/or a digital data network including a public data network such as the internet. The clients 102 may include multiple types of client capable of accessing the prediction service 104, and may each incorporate and/or be incorporated by one or more computing devices. For example, the prediction service 104 may incorporate a web-based prediction service and the clients 102 may correspond to web browsers capable of accessing the web-based prediction service. The prediction service 104 may utilize any suitable web service protocol and/or component.

The example computing environment 100 may further include one or more web sites 108 and one or more third-party services 110. For example, the web sites 108 may include manufacturer web sites, product review web sites, news web sites, and web log (“blog”) web sites. The third-party services 110 may include web-based services capable of providing data in a pre-defined format. For example, the third-party services 110 may include user interfaces, such as application programming interfaces (APIs), configured to provide product data collected and/or curated by the third-party services 110. The components, clients, networks, web sites and/or services 102-110 of the computing environment 100 may each be implemented by one or more computers and/or with any suitable distributed computing technique.

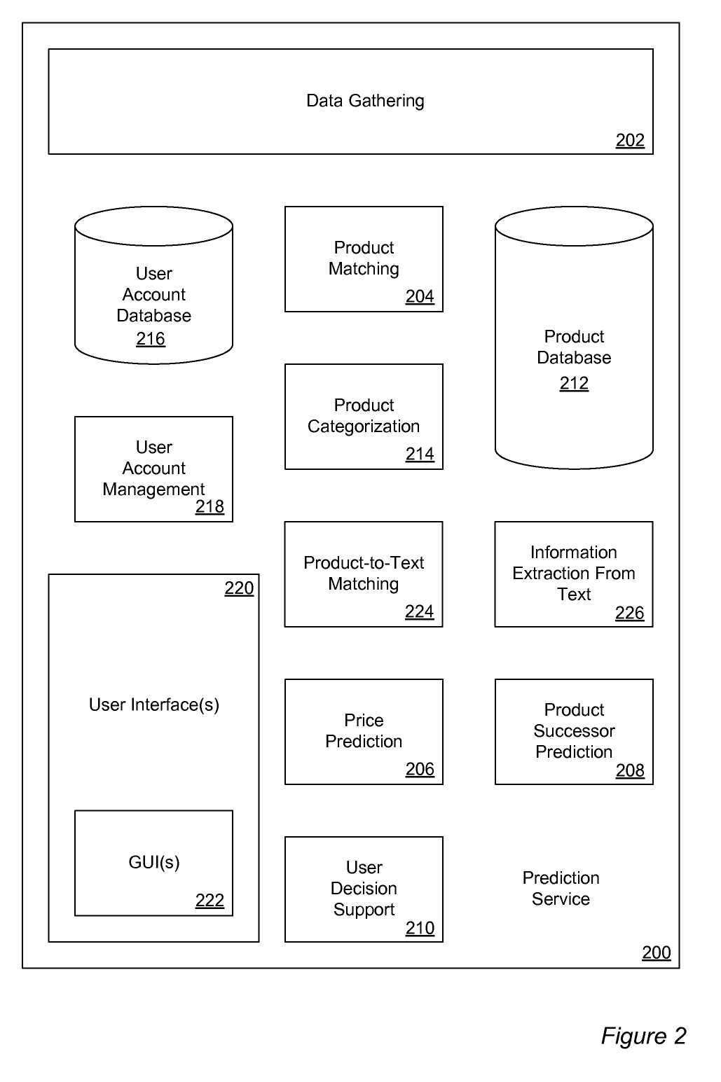

The prediction service 104 may provide product purchase timing recommendations, product successor availability predictions and/or product price predictions based on data obtained from the web sites 108 and/or the third-party services 110. FIG. 2 depicts aspects of an example prediction service 200 in accordance with at least one embodiment of the invention. The prediction service 200 of FIG. 2 is an example of the prediction service 104 of FIG. 1.

The prediction service 200 includes the following components:
1) Data gathering 202;
2) Product matching 204;
3) Text-to-product matching (224)
4) Information extraction from text (226)
5) Price prediction 206;
6) Product successor prediction 208 (also called “model prediction” herein); and
7) User decision support 210 including explanation.
   Each of these components is explained in greater detail below.

Data gathering 202: As explained in detail below, the process of gathering data may take into account relevant background information including coupons and rebates, sales tax, shipping and handling charges, model information, and then like. Moreover, various embodiments may take into account whether a product is available at physical stores (further considering the stores' physical locations vis-à-vis the customer's location), at online vendors, or both.

Product matching 204: in general, a same product can appear under a myriad of different names and seller stock-keeping units (“SKUs”). Moreover, in many cases, even the Uniform Product Code (“UPC”) associated with a product can be noisy or misleading.

Text-to-product matching 224: mentions of products or product successors can appear in various text feeds, under various terminology. This component can associate text, including free-form text, with one or more products to which the text relates, for example, utilizing machine learning techniques.

Information extraction 226: information about products can appear in text including information pertaining to future availability, prices, and technical specifications. This component may extract relevant information about products that can be inferred from text, including free-form text, for example, utilizing machine learning techniques.

Price prediction 206: the set of variables utilized by the prediction service 200 may include one or more of: product popularity, model history and new model forecasts, product category including substitute goods, brand and manufacturer, the number of sellers for the product, the availability of offers such as coupons and rebates for the product, offer price history and real-time price updates.

Model prediction 208: it may be desirable to predict when such a model is introduced and advise the consumer about the tradeoff between buying now and waiting for the new model to come out.

User decision support 210: the analytical power of the prediction service 200 may be utilized to generate product purchase timing recommendations, including buy/wait recommendations, and a variety of purchase timing decision support information including indications of predicted price movement (e.g., up, down, flat), price movement direction confidence scores, and associated predicted price movement ranges. In addition, automatically-generated explanations may be associated with a prediction and/or recommendation. Such explanations can help the customer understand and evaluate the predictions and/or recommendations.

As described in more detail below, unambiguously determining the set of available products and associating information exacted from various data feeds by the data gathering component 202 is often non-trivial. The product matching component 204 may perform such associations and update a product database 212 that includes a “universe” of validated and normalized products and product information. In accordance with at least one embodiment of the invention, such matching is a significant aspect of the operation of the prediction service 200 at least because many of the components of the prediction service 200 can depend upon the quality of the information in the product database 212. A product categorization component 214 may categorize products in the product database 212. Alternatively, or in addition, such categorization may occur as part of product matching.

The user decision support component 210 may take into account user preferences when providing predictions, recommendations and decision support information. Such user preferences may be stored in corresponding user profiles in a user account database 216 managed by a user account management component 218.

The functionality of the prediction service 200 may be accessed with one or more user interfaces 220 including one or more programmatic interfaces such as application programming interfaces (APIs), messaging interfaces in accordance with pre-defined protocols, and/or graphical user interfaces (GUIs) 222. For example, the prediction service 200 may include a web-based graphical user interface.

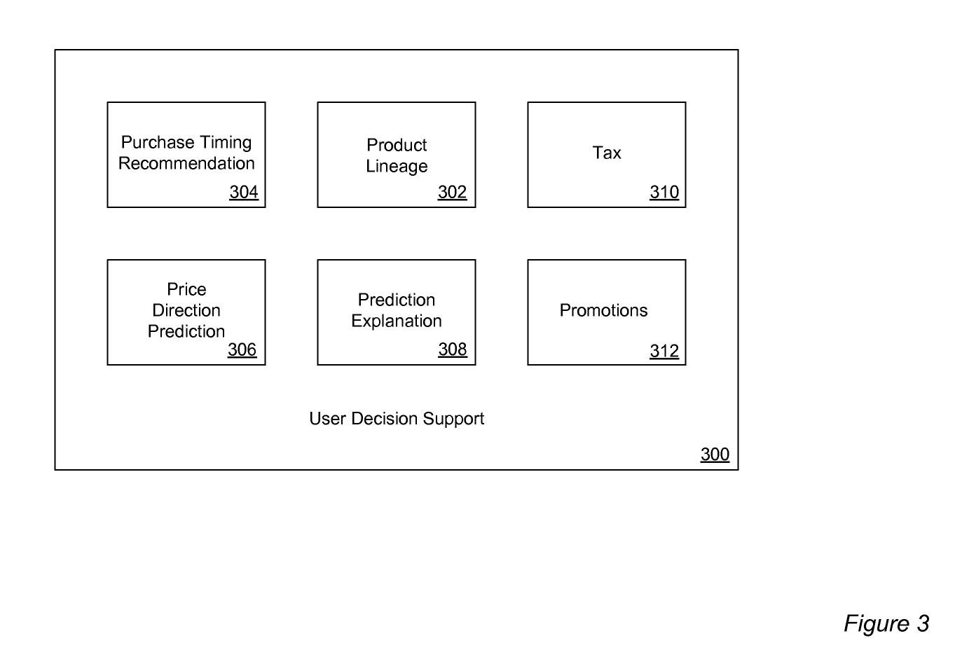

FIG. 3 depicts aspects of an example user decision support component 300 in accordance with at least one embodiment of the invention. The user decision support component 300 of FIG. 3 is an example of the user decision support component 210 of FIG. 2. The example user decision support component 300 includes a product lineage component 302 configured at least to maintain a graph of ancestor/descendant relationships (“family relationships”) among products and determine at least one optimal lineage through the graph for particular products. In accordance with at least one embodiment of the invention, such lineages can be utilized to significantly enhance user understanding of model predictions, and/or to enhance prediction quality.

The decision support component 300 may include a purchase timing recommendation component 304 configured at least to determine beneficial purchase timing recommendations based at least in part on product price and successor availability predictions. A price direction prediction component 306 may be configured at least to predict price movements during a prediction time window. A confidence (e.g., a confidence score) may be determined for price movement predictions by the price direction prediction component 306. A prediction explanation component 308 may be configured at least to determine one or more human-readable explanations for predictions made by the prediction service 200. For example, such explanations may correlate with most significant factors as determined with factor analysis and/or other methods described below. Recommendations and supporting information provided by the decision support component 300 may take into account applicable taxes and available promotions as determined by tax 310 and promotions 312 components, respectively.

Various components of the prediction service 200 (FIG. 2) and/or the user decision support component 300 (FIG. 3) may incorporate and/or be incorporated by one or more machine learning components. Such machine learning components may utilize any suitable machine learning technique. It is common for machine learning components to have a configuration or training phase that prepares the machine learning components for full operation. However, some machine learning components in accordance with at least one embodiment of the invention may also be trained and/or retrained while in full operation.

Following are more detailed discussions of various components of the prediction service 200.

### Data Gathering

This section describes the process of collecting and mining data for the purpose of enabling customers to obtain a good product while minimizing pricing “regrets”, for example, due to buying at a peak price or buying at a time when a successor's release is imminent.

Many vendors provide data files that include product names, IDs, and their prices. These data files are regularly updated, typically on a daily basis, and are known as “price feeds.” Price feeds are often available for physical stores (e.g., BestBuy), e-commerce vendors (e.g., Amazon.com), and market places (e.g., Ebay). Price feeds are typically available either directly from the vendor or from a third-party that aggregates feeds from a number of vendors and makes them more broadly available.

In certain cases, the price feeds provided by vendors can be incomplete, out-of-date, and/or inaccurate. In such cases, various embodiments may augment the vendor-provided price feeds by “scraping” the vendors' Web sites. That is, various embodiments may issue a series of http requests to the Web site causing it to send back data that includes the requisite product and price information. This data is typically in the form of HTML pages, possibly including image files and programs in scripting languages (e.g., javascript). Various embodiments may parse the pages and scripts to extract the relevant information.

A common situation that arises when “scraping” a vendor Web site is that a product is described on a Web page, but its price is not available to a shopper until after the product is “placed in the shopping cart.” Similarly, the best price may only be available once a particular code is typed in (e.g., a coupon code). In some embodiments, a “place in shopping cart” price may be determined by analyzing the script implementing this behavior (typically, javascript embedded in the Web page). In some embodiments, a code-restricted price may be determined by sending appropriate codes to the vendor in order to determine the best price available for each product.

In some embodiments, appropriate codes (e.g., coupon and/or rebate information) may be gathered from a variety of sources including Advertisements, Tweets, e-mails and news letters sent out by vendors, posts on community sites such as Slickdeals, and the like. In some embodiments, coupon “feeds” may also be obtained from Coupon aggregators.

In some embodiments text data that potentially relates to existing products or future unreleased products may be gathered from a variety of sources including product announcements, blog posts, tweets, news articles, and RSS feeds.

### Product Matching

In many embodiments, price feeds may contain many identical products that should be matched to facilitate predicting whether the lowest price of a product, across a set of retailers, is going to change in the future. Specifically, various embodiments may identify that a given set of retailer products correspond to a single unique manufacturer product. Thus, the input to product matching is a set of retailer products. The output is a product partitioning into matched product sets. Product matching is symmetric—the matched products are considered ‘equal’.

### Product Matching Approaches

While products can be matched based on various attributes, in many embodiments, UPC and Model may be convenient to deal with.

### UPC-Based Product Matching

A UPC identifies a given unique product. Thus, multiple retailers carrying the same product should generally have the same UPC for the product in their data. If all retailers carrying a given unique product have the same UPC for the product, than it is frequently fairly easy to identify the products that should be matched. However, in some cases, data from many retailers (approximately 40% of retailers) may omit UPC data entirely, meaning that its products cannot be matched by a UPC approach. In other cases, data from a retailer may ostensibly include UPC data, but the UPC data is “dirty” or invalid. Moreover, in some cases, a given unique product may be associated with more than one UPC, making it difficult to match such products using a UPC approach.

### Model-Based Product Matching

In some embodiments, model-based matching may be employed to identify related products. Normally, manufacturers use model numbers to uniquely identify their products. Hence, retailer products can sometimes be matched based on the brand (manufacturer) and model number. However, brand and model data can be quite dirty in many cases. Consequently, before matching products, it may in some embodiments be desirable to match brands and models into unique (representative) strings. This process is similar to product matching, except that the ultimate goal is normalization of the brand and model data rather than matching UPC codes.

### Model-Based Product Matching: Matching Input and Output

In some embodiments, the input to a product matching and mapping process can be stored as a set of data (e.g. database table or file). For example, an individual record in a database table may correspond to a single offer from a single merchant, and include some or all of the following columns:
upc and/or can (the latter representing an International Article Number or “EAN”);
source_id—an identifier corresponding to the retailer selling the product, e.g., in one embodiment, Amazon.com may correspond to a source_id of ‘1’;
retailer_id—the retailer's identifier for the product, e.g., an Amazon Standard Identification Number (“ASIN”) for Amazon.com;
manufacturer—manufacturer or brand (used for model matching);
model or mpn—used for model matching.
   An offer by a retailer of a product may be identified uniquely by a source_id, retailer_id pair. In example database queries illustrated in this section, this set of data is stored in a table named “historical_products”.

In some embodiments, the output of a product matching and mapping process is a mapping that associates each source_id, retailer_id pair with an entry in a unique_product_id column. For example, retailer products having the same unique_product_id may be considered matched and/or the same product for purposes of this description. In accordance with at least one embodiment, approximately three-million products may be matched in approximately 30 minutes.

### Incremental Updates

In many cases, only a small number of new products may be introduced per day. Accordingly, in many embodiments, a product matching and mapping may be performed incrementally. For example, in accordance with at least one embodiment, a set of source_id,retailer_id pairs may be identified as needing to be matched (e.g., they are not mapped to a unique_product_id). Those historical products may then be matched to an existing unique_product_id or determined to be a completely new product, and given a new unique_product_id.

In some embodiments, such incremental matching and mapping is significantly faster non-incremental product matching and mapping, taking only 10 minutes or so in accordance with at least one embodiment. In some embodiments, data validation may be performed before and/or after incremental matching and mapping as described in section “Pre- and Post-Validation,” below.

### UPC Cleaning and Validation

A UPC is supposed to uniquely identify a product. Typically, products with different Manufacturer Part Numbers (“MPNs”) will have different UPCs.

In some embodiments, it may be desirable to use UPCs as unique keys in the system's products database. Unfortunately, it may be the case that retailer product offers lack UPC data. Consequently, some embodiments may match those products against ones with UPC data. However, for product matching it may be desirable that UPC data be clean, but as discussed above, this is often not the case.

For example, the products database in accordance with at least one embodiment may include approximately 700,000 products. Of those 700,000 products, approximately 55,000 may have an empty string as a UPC, and another 150,000 products have NULL as UPC. These UPC's are considered invalid.

For another example, many UPCs provided in price feeds have inconsistent leading-zero representation. UPCs often start with a leading zero, but leading zeros are sometimes dropped by merchants in their internal UPC representation. In a products database in accordance with at least one embodiment, UPC lengths may be distributed as shown in Table 1.

TABLE 1

| len | count |
|---|---|
| 0 | 55634 |
| 1 | 4 |
| 3 | 9 |
| 4 | 8 |
| 5 | 1 |
| 7 | 2 |
| 8 | 9 |
| 9 | 5 |
| 10 | 7 |
| 11 | 701 |
| 12 | 423587 |
| 13 | 35426 |
| 14 | 17212 |
| 15 | 117 |
| 16 | 4 |
| 20 | 2 |
| | 155211 |

A standard UPC should have 12 digits. An EAN (which includes a country code) is 13-digits long and starts with a 0 for US companies. Some embodiments may add a leading zero for 11-digit UPCs for consistency. Some retailers (e.g. buy.com) may use alternate identifiers, such as 14-digit Global Trade Item Numbers (“GTINs”) for at least some products. However, in some embodiments, GTINs may not be easily converted or mapped to UPC and/or EAN identifiers. (E.g., simply dropping the first 2 digits of a GTIN does not result in a valid UPC.) In some embodiments, identifiers that are shorter than 11 digits may be considered invalid.

In addition, some retailers add a suffix (e.g., “-R” or ‘r’) to the UPC to distinguish refurbished products, e.g., 27242771727-R. In some embodiments, such suffixes are dropped from UPCs for refurbished products. Similarly, a small number of products have dashes (e.g., 0-84438-30689-7) or spaces (e.g., 6 56777 00543 6) in their UPC codes. In some embodiments, such dashes and/or spaces are removed from UPC codes.

Furthermore, in some cases, UPC data may include other bad data, such as a product model string, or the like. In some embodiments, such non-digit data are removed from UPC codes.

Multiple Products with the Same UPC

Normally, a <source_id, retailer_id> pair should uniquely identify a product. Since a UPC is also a unique product identifier, it follows that no two different products from a single retailer can have the same UPC. However, that is not always the case:
A retailer can have a new and a not-so-new version of a product (e.g. used or refurbished), in which case the product might have two retailer ids.
A retailer can mistakenly create two (or more) entries for the same product.
A retailer can mistakenly enter the same UPC for two different products (black and white, or 8 GB and 16 GB).

To deal with the first case, some embodiments filter out all non-new products (representing a fraction of 1% of all products). Some embodiments treat the second and third cases as bad data and set UPC to NULL when a single UPC has several matching retailer ids. Table 2 includes example data from a products database in accordance with at least one embodiment.

select source_id, model, retailer_id, name from
historical_products where upc=‘000000007023’

TABLE 2

| Source_id | Model | Retailer_id | name |
|---|---|---|---|
| 1 | Z0GP00062 | 46762 | Apple MacBook Pro 2.66 GHz |
| | | | Intel Core i7 Processor Silver |
| | | | Notebook Computer- |
| | | | Z0GP00062 |
| 1 | Z0GP0005P | 46763 | Apple MacBook Pro 2.66 GHz |
| | | | Intel Core i7 Processor Silver |
| | | | Notebook Computer - |
| | | | Z0GP0005P |
| 1 | Z0GP00002 | 46759 | Apple MacBook Pro 2.66 GHz |
| | | | Intel Core i7 Processor Silver |
| | | | Notebook Computer - |
| | | | Z0GP00002 |
| 1 | Z0J60003V | 46753 | Apple MacBook Pro 2.66 GHz |
| | | | Intel Core i7 Silver Notebook |
| | | | Computer - Z0J60003V |
| 1 | Z0J600058 | 46744 | Apple MacBook Pro 2.66 GHz |
| | | | Intel Core i7 Silver Notebook |
| | | | Computer - Z0J600058 |

In accordance with at least one embodiment, the UPC may be set to NULL for all of these products and a product matching process (as described above) used to assign correct UPCs for each. (The provided UPC appears to be completely wrong because Amazon.com has a beauty product with the same UPC.)

In accordance with at least one embodiment, UPC data may be cleaned according to a UPC-cleaning process similar to the following.
1) Do some rough cleaning before replacing UPCs with EANs; replace short UPCs and non-digit UPCs with NULLs:

UPDATE historical_products
SET upc = NULL
WHERE length(upc) < 11 OR upc = ‘000000000000’;

2) Replace UPCs with EANs when UPC is null

UPDATE historical_products
SET upc = ean
WHERE upc IS NULL AND ean IS NOT NULL;

3) Remove -R suffixes (the WHERE clause is for performance)

UPDATE historical_products
SET upc = replace(upc, ‘R’, ‘’)
WHERE upc LIKE ‘%R’;

4) Remove dashes and spaces

UPDATE historical_products
SET upc = trim(replace(upc, ‘-’, ‘’))
WHERE upc LIKE ‘%-%’ OR upc LIKE ‘% %’;

5) Replace short UPCs and non-digit UPCs with NULLs (again, in case some EANs are dirty):

UPDATE historical_products
SET upc = NULL
WHERE length(upc) < 11 OR length(upc) > 14 OR upc
RLIKE ‘[\hat{ }0-9]’ OR upc = ‘000000000000’;

6) Add a leading zero to 11-digit UPCs

UPDATE historical_products
SET upc = concat(‘0’ , upc)
WHERE length(upc) = 11;

7) Remove leading zero from 14-digit GTINs

UPDATE historical_products
SET upc = substr(upc, 2, 13)
WHERE length(upc) = 14 AND upc LIKE ‘0%’;

8) Remove leading zero from 13-digit EANs

UPDATE historical_products
SET upc = substr(upc, 2, 12)
WHERE length(upc) = 13 AND upc LIKE ‘0%’;

At the end, as shown in Table 3, only 12-UPCs, 13-digit EANs, and 14-digit GTINs should remain in the data.

TABLE 3

| len | count |
|---|---|
| 12 | 445468 |
| 13 | 29383 |
| 14 | 271 |
| | 212817 |

In some embodiments, UPC-cleaning process may further include nullifying ambiguous UPCs, as follows.

UPDATE historical_products
SET upc = NULL
WHERE EXISTS (
SELECT 1
FROM historical_products AS hp
WHERE historical_products.source_id = hp.source_id AND
historical_products.upc = hp.upc
HAVING count(distinct retailer_id) > 1
)

In some embodiments, the ambiguous UPCs may be pre-computed prior to the UPC-cleaning process.

### Brand/Model Normalization

The same brand or model name for a product can exhibit many variations within data feeds. Consequently, normalizing brand names and model names can be a significant component of model-based product matching. While this section talks primarily about brand matching, the techniques described here are also applicable to matching model names and potentially other entities like product names, product categories from different sources and the like.

Brand matching relates to the problem of matching different text strings representing the same brand or manufacturer. Brand-matching problems can arise because different vendors (data sources) are likely to use somewhat different ways to enter the same brand. For a trivial example, one vendor can use all-capital letters in their data, e.g., “HEWLETT PACKARD”, whereas another vendor can capitalize the words in the name, e.g., “Hewlett Packard”. The problem gets harder when a brand has many common names or divisions. For example, “Hewlett Packard”, can also be represented as “HP”, “Hewlett-Packard”, “Hewlett Packard Company”, “HP/Compaq”, and the like. The problem then is to be able to match all those values into a single brand name.

In some embodiments, brand matching is important because it can enable search-by-brand both on the live site and internally. In addition, brand matching can improve product matching quality. For example, when matching products by model name (“mpn”), very short mpns (e.g., 4024, and the like) cause many false matchings. By adding brand matching, mpn-based product matching can be made more accurate.

There are at least two approaches to brand matching. One is to use some kind of a string-based similarity metric. This approach can easily handle cases like lower vs. upper case, optional hyphenation, and misspelling. Unfortunately, text-based matching may not be able to match completely different representations of the same brand such as HP vs. Hewlett Packard.

In some embodiments, data mining techniques based on product equality may provide better results than string-based similarity metrics. In particular, most product records in the system's database have a UPC code that uniquely determines a product, and that information can be used to match different encodings of the same brand. For example, if the system's data contains the records shown in Table 4, some embodiments may conclude that HP and Hewlett Packard are different names of the same brand.

TABLE 4

| UPC | brand |
|---|---|
| 884420794271 | HP |
| 884420794271 | Hewlett Packard |

Formally, the data can be characterized as a bi-partite graph BP where one set of nodes represents brands (B) and a different set of nodes represents products (P). The problem then is to partition B into sets of equivalent brand names. In general, brand partitioning can be fuzzy as discussed below.

Note, that the BP graph is actually a multi-graph since there can be multiple edges between a given brand Bi and a given product Pj representing multiple data sources (vendors) using the same brand name. Intuitively, that should provide additional weight Bi as a brand name for Pj.

### Brand Matching Metrics

There are several ways to approach the above bi-partite problem. For example, the problem can be converted into one of market-basket mining as follows. A UPC can be thought of a purchase transaction and each brand name as a purchased item. Then, the problem is equivalent to finding items that are frequently bought together. Below are discussed some terminology and accuracy metrics from data mining.

Single seller case—a simple approach is to assume that there is only one seller. In this case, data can be assumed to be a set of unique tuples <Product, Brand>. The support of a brand can be defined using the traditional data mining approach: support(B)=|<*, B>| where ‘*’ denotes any product.

Similarly, joint support for a pair of brands B1 and B2 can be defined as the number of products that occur under both brands: support(B1,B2)=|<P,B1>: exists <P, B2>| which is the same as the size of the join of the product set of the two brands, i.e., |{<P, B1>}×{<P, B2>}|.

In some embodiments, joint support alone could be used to identify matching brands. For example, with the assumption that support(B1, B2)>=10, B1 and B2 could be matched. However, this approach may be problematic, insofar as some brands may have fewer than, for example, ten products, but brands matching may still be possible. At the same time, other brands can have thousands of products, and ten common products may be insufficient for brand matching. For example, a single vendor could mistakenly put Dell as the brand instead of HP in some of their records. Since there are hundreds of HP and Dell products, various embodiments should be robust to this kind of noise in the data.

Similarity is another metric of brand matching that may be used in some embodiments:

similarity(B1, B2) =
support(B1, B2) / sqrt(support(B1) * support(B2))

Similarity(B1, B2) is a value between 0 and 1 with 1 representing a perfect coincidence of B1 and B2; i.e., for every product record <B1, P> there is also a record <B2, P> and vice versa. The problem with similarity is that it needs support(B1) and support(B2) to be pretty close. Otherwise, similarity(B1, B2) will get a very low score.

In many embodiments, however, this result may be unsatisfactory. There may be a few product records with ‘H.P.’ as brand and a few hundred ‘HP’ records. If every H.P. product is also an HP product, ‘H.P.’ should be expected to match ‘HP.’ This example also suggests that perhaps an asymmetric brand-similarity metric, such as confidence, may be desirable.

Confidence is used in data mining to measure goodness of association rules. It is defined as follows:

confidence(B1->B2)=support(B1,B2)/support(B1)

Intuitively, confidence measures the conditional probability that a product branded B1 is also branded B2. In data mining, confidence is typically used with support. E.g., an item association is considered interesting if it has at least 1% support and 90% confidence. In some embodiments, a lower confidence threshold should be acceptable since some products may not appear under both brands. The downside of confidence as a metric is that commonly occurring brands are more likely to match a given brand than less common brands because joint support with a popular brand is likely to be higher.

Multiple seller case—In some embodiments, the system's data may contain multiple product-brand records corresponding to multiple sellers (data sources) supplying the same brand value for a given product. Thus, the data can be viewed as a set of tuples {<P, S, B>} where P is a product, S is a seller (data source), and B is a brand. Note that under this definition, a product is counted as many times as there are sellers for the product. In this case support of brand B can be defined as follows (where ‘*’ denotes any seller):

support(B)=sum_{—}P(support(B,P))=sum_{—}P(|<P,*,B>|)

Generally speaking, joint support in the multiple-seller case can be defined as follows:

joint_support(B1, B2) = sum_P(joint_support(B1, B2,
P))

However, in various embodiments, various approaches could be used to derive joint support in the multiple-seller case. For example, in one embodiment, joint support could be defined as follows:

support(B1, B2, P) = min(support(B1, P), support(B2,
P))

In another embodiment, joint support may be sensibly defined as follows:

support(B1,B2,P)=|{<B1,P>}×{<B2,P>}|

In embodiments in which it may be desirable estimate confidence, joint support may be defined as a support_ratio (B1, B2), as follows:

support_ratio(B1, B2) = | {<B1, P>} x {<B2, P>}| /
|<*, P> x <P, *>|

In such embodiments, a confidence estimate may be obtained as follows:

support_ratio(B1,B2)/support_ratio(B1)

In some embodiments, a SimRank-based algorithm may be utilized to derive joint support.

Practical approach—In some embodiments, the following approach could be used to identify brand matchings. If support(B1, B2)>=5, confidence(B1,B2) must be above X %. Else, if support(B1, B2)>=3, confidence(B1,B2) must be above Y %. The biggest problem of this common-sense approach is discontinuity. In addition, there is no single score to measure matching quality although confidence could work. In some embodiments, these problems may be resolved with a different matching metric.

In some embodiments, the data resulting from the above-described brand-matching processes may include multiple brand matchings for a given brand. In addition, there may be cycles in the matching graph. Thus, in some embodiments, additional brand normalization may be desirable.

### Brand Normalization

As the term is used herein, “brand normalization” refers to selecting a single representative brand from a given set of matched brands. Intuitively, the single representative brand may be selected as either the most common brand among the brands matching a given brand or the brand that matches with most confidence.

Iterative algorithm—In some embodiments, brand normalization may require several iterations since brand matching may require transitive closure: if B1 matches B2, B2 matches B3. To avoid infinite recursion, brand B1 should be matched with B2 only if support(B2)>support(B1). This also makes common sense. (As a refinement B1 could be replaced with B2 if their supports are equal but <B1,B2> has higher confidence than <B2, B1>).

It is easy to verify that replacing B1 with B2 results in higher confidence rules, i.e., confidence(B, B1)>=confidence(B, B1 U B2). Thus, iterative brand normalization is a consistent algorithm.

If brand normalization is integrated with product matching, the two can be run iteratively, one after the other. (Note that the described normalization algorithm is a form of brand clustering where every most-representative brand defines its own cluster.)

Missing brand data—In addition to brand normalization, some embodiments may fill in missing brand data whenever possible. In some embodiments, the missing brand data can be filed in based on the results of product matching. The brand value in the authority product record will be used for all of the products in the matched set.

In accordance with at least one embodiment, a brand-normalization script may be used, as described in the following example using data related to “Hewlett Packard” or “HP.”

In accordance with at least one embodiment, the brand-normalization script uses a low minimum support value (e.g., 2) by default. Table 5, below, shows the results of one iteration of the algorithm for HP-derived records in a set of exemplary data. Note that the MySQL is case-insensitive so ‘HEWLETT PACKARD’ and ‘Hewlett Packard’ are considered the same value. Also note that another iteration of the algorithm would have mapped everything to ‘HP’.

select brand1, brand2, support1, support2,
joint _ support AS jnt_sup, joint_support/support1 AS
confid from brand_ mappings where
joint_ support/support1 > 0.1 and (brand1 like ‘hp %’
or brand1 like ‘hewl%’) limit 100

TABLE 5

| brand1 | brand2 | support1 | support2 | jnt_sup | confid |
|---|---|---|---|---|---|
| HEWLETT | HP | 3193 | 4185 | 774 | 0.2424 |
| PACKARD | | | | | |
| HEWLETT | HP | 193 | 4185 | 29 | 0.1503 |
| PACKARD - DAT | | | | | |
| 3C | | | | | |
| HEWLETT | HP | 47 | 4185 | 37 | 0.7872 |
| PACKARD - DESK | | | | | |
| JETS | | | | | |
| HEWLETT | HP | 45 | 4185 | 12 | 0.2667 |
| PACKARD - | | | | | |
| DESKTOP | | | | | |
| OPTIONS | | | | | |
| HEWLETT | Hewlett Packard | 3 | 3193 | 2 | 0.6667 |
| PACKARD - | | | | | |
| DESKTOPS | | | | | |
| HEWLETT | HP | 6 | 4185 | 3 | 0.5000 |
| PACKARD - | | | | | |
| HANDHELDS & | | | | | |
| OPTNS | | | | | |
| HEWLETT | HP | 360 | 4185 | 306 | 0.8500 |
| PACKARD - INK | | | | | |
| SAP | | | | | |
| HEWLETT | HP | 91 | 4185 | 33 | 0.3626 |
| PACKARD - | | | | | |
| LASER | | | | | |
| ACCESSORIES | | | | | |
| HEWLETT | HP | 193 | 4185 | 181 | 0.9378 |
| PACKARD - | | | | | |
| LASER JET | | | | | |
| TONERS | | | | | |
| HEWLETT | HP | 45 | 4185 | 27 | 0.6000 |
| PACKARD - | | | | | |
| LASER JETS | | | | | |
| HEWLETT | HP | 38 | 4185 | 16 | 0.4211 |
| PACKARD - | | | | | |
| MEDIA 7A | | | | | |
| HEWLETT | HP | 111 | 4185 | 61 | 0.5495 |
| PACKARD - | | | | | |
| MEDIA SAP | | | | | |
| HEWLETT | HP | 26 | 4185 | 14 | 0.5385 |
| PACKARD - | | | | | |
| MONITORS | | | | | |
| HEWLETT | HP | 88 | 4185 | 27 | 0.3068 |
| PACKARD - | | | | | |
| NOTEBOOK | | | | | |
| OPTIONS | | | | | |
| HEWLETT | HP | 12 | 4185 | 4 | 0.3333 |
| PACKARD - | | | | | |
| PROCURVE | | | | | |
| NTWRKNG | | | | | |
| HEWLETT | HP | 45 | 4185 | 18 | 0.4000 |
| PACKARD - | | | | | |
| PROLIANT | | | | | |
| SERVERS | | | | | |
| HEWLETT | HP | 19 | 4185 | 11 | 0.5789 |
| PACKARD - | | | | | |
| SCANNERS | | | | | |
| HEWLETT | Hewlett Packard | 215 | 3193 | 30 | 0.1395 |
| PACKARD - | | | | | |
| SERVER OPTIONS | | | | | |
| HEWLETT | Hewlett Packard | 21 | 3193 | 14 | 0.6667 |
| PACKARD - THIN | | | | | |
| CLIENTS | | | | | |
| HEWLETT | hewlett packard | 35 | 3193 | 21 | 0.6000 |
| PACKARD - | | | | | |
| WORKSTATION | | | | | |
| OPTNS | | | | | |
| HEWLETT | Hewlett Packard | 4 | 3193 | 4 | 1.0000 |
| PACKARD - | | | | | |
| WORKSTATIONS | | | | | |
| HEWLETT | HP | 14 | 4185 | 5 | 0.3571 |
| PACKARD/HP | | | | | |
| HEWLETT | HP | 14 | 114 | 5 | 0.3571 |
| PACKARD/HP | NETWORKING | | | | |
| Hewlett Packard | Hewlett Packard | 5 | 3193 | 3 | 0.6000 |
| Commercial PCs | | | | | |
| HEWLETT | HP | 220 | 4185 | 120 | 0.5455 |
| PACKARD | | | | | |
| COMPANY | | | | | |
| HEWLETT | hewlett packard | 27 | 3193 | 9 | 0.3333 |
| PACKARD POS - | | | | | |
| SMARTBUY | | | | | |
| Hewlett Packard | HEWLETT | 7 | 91 | 2 | 0.2857 |
| Printing & Imaging | PACKARD - | | | | |
| | LASER | | | | |
| | ACCESSORIES | | | | |
| Hewlett-Packard | HP | 657 | 4185 | 480 | 0.7306 |
| HEWLETT- | HP | 11 | 4185 | 10 | 0.9091 |
| PACKARD | | | | | |
| CALCULATORS | | | | | |
| HP (Canada) | HP | 3 | 4185 | 3 | 1.0000 |
| HP (Hewlett- | HP | 18 | 4185 | 12 | 0.6667 |
| Packard) | | | | | |
| HP - COMPAQ | HEWLETT | 3 | 3193 | 2 | 0.6667 |
| COMMERCIAL | PACKARD | | | | |
| STORAGE | | | | | |
| HP - COMPAQ | Hewlett Packard | 2 | 3193 | 2 | 1.0000 |
| DESKTOP | | | | | |
| OPTIONS | | | | | |
| HP - COMPAQ | HP | 4 | 4185 | 4 | 1.0000 |
| MONITORS | | | | | |
| HP - COMPAQ | Hewlett Packard | 33 | 3193 | 17 | 0.5152 |
| SERVER OPTIONS | | | | | |
| HP - COMPAQ | HP | 25 | 4185 | 16 | 0.6400 |
| SERVERS | | | | | |
| HP - COMPAQ | Hewlett Packard | 3 | 3193 | 2 | 0.6667 |
| WORKSTATION | | | | | |
| OPTIONS | | | | | |
| HP - COMPAQ | HP | 3 | 4185 | 2 | 0.6667 |
| WORKSTATION | | | | | |
| OPTIONS | | | | | |
| HP - COMPAQ | HP - | 25 | 37 | 16 | 0.6400 |
| WORKSTATIONS | WORKSTATION | | | | |
| | SMART BUY | | | | |
| HP - DESKTOP | Hewlett Packard | 33 | 3193 | 24 | 0.7273 |
| SMART BUY | | | | | |
| HP - HP | HP | 8 | 4185 | 4 | 0.5000 |
| DESIGNJET | | | | | |
| PRINTERS | | | | | |
| HP - ISS SERVER | HP | 12 | 4185 | 3 | 0.2500 |
| OPTIONS (PL SI) | | | | | |
| HP - NOTEBOOK | HP | 55 | 4185 | 40 | 0.7273 |
| SMART BUY | | | | | |
| HP - SWD | HEWLETT | 3 | 193 | 3 | 1.0000 |
| VOLUME | PACKARD - DAT | | | | |
| LEFTHAND (PL J2) | 3C | | | | |
| HP - | Hewlett Packard | 37 | 3193 | 26 | 0.7027 |
| WORKSTATION | | | | | |
| SMART BUY | | | | | |
| HP Business | HP | 35 | 4185 | 19 | 0.5429 |
| HP Consumer | HP | 17 | 4185 | 9 | 0.5294 |
| HP ISS | HEWLETT | 38 | 3193 | 22 | 0.5789 |
| | PACKARD | | | | |
| HP Legacy | HP | 4 | 4185 | 3 | 0.7500 |
| HP | HP | 114 | 4185 | 45 | 0.3947 |
| NETWORKING | | | | | |
| HP | HEWLETT- | 42 | 657 | 8 | 0.1905 |
| NETWORKING | PACKARD | | | | |
| (3COM) | | | | | |
| HP ProCurve | HP | 7 | 114 | 3 | 0.4286 |
| | NETWORKING | | | | |
| HP PROCURVE | HEWLETT | 38 | 3193 | 14 | 0.3684 |
| H3C DISCOUNT J | PACKARD | | | | |
| HP Server | HEWLETT | 13 | 3193 | 7 | 0.5385 |
| Accessories | PACKARD | | | | |
| HP Servers | Hewlett Packard | 6 | 3193 | 2 | 0.3333 |
| HP Servers | HP | 6 | 4185 | 2 | 0.3333 |
| HP StorageWorks | HEWLETT | 7 | 193 | 4 | 0.5714 |
| | PACKARD - DAT | | | | |
| | 3C | | | | |

While the results shown in Table 5 may be impressive, Table 5 does not show what the algorithm missed. The total number of HP-derived names in the data is 112, and 75 of those names have a support of 2 or higher. Plus, there are some ambiguous matchings above (e.g., HP Servers is matched to both HP and Hewlett Packard), but confidence or support (B2) can be used to brake the ties. Table 6, below, shows the names that failed to match:

select brand, support from brand_supports where (brand
like ‘hp %’ or brand like ‘hewl%’) and not exists
(select 1 from brand_ mappings as bm where
brand_supports.brand = bm.brand1)

TABLE 6

| brand | support |
|---|---|
| HEWLET | 3 |
| Hewlett Packard (Consumables) | 12 |
| Hewlett Packard (HP) | 2 |
| HEWLETT PACKARD - BLADE OPTIONS | 2 |
| HEWLETT PACKARD - DIRECT CONNECT | 3 |
| HEWLETT PACKARD - HANDHELDS & OPT | 2 |
| HEWLETT PACKARD - INTL (SAP) | 7 |
| HEWLETT PACKARD - PLOTTERS | 5 |
| HEWLETT PACKARD - PROJECTORS | 8 |
| HEWLETT PACKARD - WORKSTATION DISPL | 2 |
| Hewlett Packard Accessories | 4 |
| Hewlett Packard Office | 2 |
| Hewlett Packard Pcdo | 79 |
| HP - COMPAQ COMMERC STORAGE NON CRP | 2 |
| HP - HP PRINTER BASED MFP | 3 |
| HP - HP STORAGEWORKS | 2 |
| HP - ISS SOFTWARE (PL 4U) | 2 |
| HP - SMARTBUY SERVERS | 2 |
| HP Compaq | 34 |
| HP H3C DISCOUNT J | 3 |
| HP PROCURVE NETWORKING | 4 |

For example, HP Compaq failed to match because this name is used by a single seller only selling laptop accessories rather than actual HP laptops. Hewlett Packard Pcdo failed to match for a similar reason (printer ink using EANs rather than UPCs).

Making sense of low confidence—While the example above illustrates the efficacy of brand matching, it also highlights the problem of selecting the minimum support/confidence values. Setting minimum support to 2 makes sense intuitively since the data is pretty clean—it is unlikely that the wrong brand occurs in the data; more likely some variation of the correct brand occurs in the data.

In some embodiments, selecting an appropriate confidence threshold can be challenging. In the HP example above, it appears that the confidence threshold would have to be set to essentially zero to capture all relevant matching. The need to use such low confidence is a consequence of the way in which brand support is computed. Suppose support(H-P)=10, i.e., there are 10 unique products under the H-P brand in the data. If a new retailer offers 10 H-P calculators that nobody else is selling, support(H-P) will become 20 but joint_support(H-P, B) will remain unchanged for all other brands B since there are no other-brand records for the calculators in the database.

Thus, in some embodiments, a better way to define support of brand B is to count the number of products that appear under B and at least one other brand. Then, setting the minimum confidence threshold at say 50% for a rule B1->B2 would mean that 50+% of the time B1 products also appear as B2 products. Accordingly, B2 might be a better name than B1.

Table 7, below, shows the results of HP-related brand mappings under the new support semantics.

TABLE 7

| | | sup- | sup- | joint_sup- | |
|---|---|---|---|---|---|
| brand1 | brand2 | port1 | port2 | port | confid |
| Hewlett Packard | HP | 688 | 1857 | 547 | 0.7951 |
| HEWLETT | HP | 69 | 1857 | 18 | 0.2609 |
| PACKARD - | | | | | |
| DAT 3C | | | | | |
| HEWLETT | HP | 36 | 1857 | 36 | 1.0000 |
| PACKARD - | | | | | |
| DESK JETS | | | | | |
| HEWLETT | Hewlett | 28 | 36 | 14 | 0.5000 |
| PACKARD - | Packard | | | | |
| DESKTOP | Acces- | | | | |
| OPTIONS | sories | | | | |
| HEWLETT | HP | 4 | 1857 | 3 | 0.7500 |
| PACKARD - | | | | | |
| HANDHELDS & | | | | | |
| OPTNS | | | | | |
| HEWLETT | HP | 331 | 1857 | 303 | 0.9154 |
| PACKARD - | | | | | |
| INK SAP | | | | | |
| HEWLETT | Hewlett | 50 | 496 | 35 | 0.7000 |
| PACKARD - | Packard | | | | |
| LASER | Printing & | | | | |
| ACCESSORIES | Imaging | | | | |
| HEWLETT | HP | 182 | 1857 | 178 | 0.9780 |
| PACKARD - | | | | | |
| LASER JET | | | | | |
| TONERS | | | | | |
| HEWLETT | HP | 36 | 1857 | 29 | 0.8056 |
| PACKARD - | | | | | |
| LASER JETS | | | | | |
| HEWLETT | HP | 26 | 1857 | 14 | 0.5385 |
| PACKARD - | | | | | |
| MEDIA 7A | | | | | |
| HEWLETT | Hewlett | 98 | 496 | 87 | 0.8878 |
| PACKARD - | Packard | | | | |
| MEDIA SAP | Printing & | | | | |
| | Imaging | | | | |
| HEWLETT | HP | 24 | 1857 | 22 | 0.9167 |
| PACKARD - | | | | | |
| MONITORS | | | | | |
| HEWLETT | HP | 41 | 1857 | 21 | 0.5122 |
| PACKARD - | | | | | |
| NOTEBOOK | | | | | |
| OPTIONS | | | | | |
| HEWLETT | HP | 43 | 1857 | 35 | 0.8140 |
| PACKARD - | | | | | |
| PROLIANT | | | | | |
| SERVERS | | | | | |
| HEWLETT | HP | 11 | 1857 | 11 | 1.0000 |
| PACKARD - | | | | | |
| SCANNERS | | | | | |
| HEWLETT | HP | 90 | 1857 | 38 | 0.4222 |
| PACKARD - | | | | | |
| SERVER | | | | | |
| OPTIONS | | | | | |
| HEWLETT | HP | 16 | 1857 | 11 | 0.6875 |
| PACKARD - | | | | | |
| THIN CLIENTS | | | | | |
| HEWLETT | Hewlett | 4 | 688 | 3 | 0.7500 |
| PACKARD - | Packard | | | | |
| WORKSTATION | | | | | |
| DISPL | | | | | |
| HEWLETT | HP | 19 | 1857 | 17 | 0.8947 |
| PACKARD - | | | | | |
| WORKSTATION | | | | | |
| OPTNS | | | | | |
| HEWLETT | Hewlett | 2 | 688 | 2 | 1.0000 |
| PACKARD - | Packard | | | | |
| WORKSTATIONS | | | | | |
| Hewlett Packard | HEWLETT | 36 | 41 | 16 | 0.4444 |
| Accessories | PACKARD - | | | | |
| | NOTEBOOK | | | | |
| | OPTIONS | | | | |
| Hewlett Packard | Hewlett | 4 | 688 | 4 | 1.0000 |
| Calculators | Packard | | | | |
| HEWLETT | HP | 119 | 1857 | 103 | 0.8655 |
| PACKARD | | | | | |
| COMPANY | | | | | |
| Hewlett Packard | HEWLETT | 2 | 50 | 2 | 1.0000 |
| JetDirect 6A | PACKARD - | | | | |
| | LASER | | | | |
| | ACCES- | | | | |
| | SORIES | | | | |
| HEWLETT | HP | 7 | 1857 | 6 | 0.8571 |
| PACKARD POS- | | | | | |
| SMARTBUY | | | | | |
| Hewlett Packard | HP | 496 | 1857 | 409 | 0.8246 |
| Printing & Imaging | | | | | |
| Hewlett-Packard | HP | 473 | 1857 | 419 | 0.8858 |
| HEWLETT- | HP | 10 | 1857 | 10 | 1.0000 |
| PACKARD | | | | | |
| CALCULATORS | | | | | |
| HP (Canada) | HEWLETT | 2 | 119 | 2 | 1.0000 |
| | PACKARD | | | | |
| | COMPANY | | | | |
| HP (Hewlett- | HP | 10 | 1857 | 9 | 0.9000 |
| Packard) | | | | | |
| HP - COMPAQ | HEWLETT | 3 | 90 | 3 | 1.0000 |
| SERVER | PACKARD - | | | | |
| OPTIONS | SERVER | | | | |
| | OPTIONS | | | | |
| HP - DESKTOP | HP | 52 | 1857 | 48 | 0.9231 |
| SMART BUY | | | | | |
| HP - HP | HP | 2 | 1857 | 2 | 1.0000 |
| DESIGNJET | | | | | |
| PRINTERS | | | | | |
| HP - NOTEBOOK | Hewlett | 54 | 688 | 51 | 0.9444 |
| SMART BUY | Packard | | | | |
| HP - SWD | HEWLETT | 3 | 69 | 3 | 1.0000 |
| VOLUME | PACKARD - | | | | |
| LEFTHAND | DAT 3C | | | | |
| (PL J2) | | | | | |
| HP - | HP | 24 | 1857 | 13 | 0.5417 |
| WORKSTATION | | | | | |
| SMART BUY | | | | | |
| HP Business | Hewlett | 3 | 688 | 2 | 0.6667 |
| | Packard | | | | |
| HP Consumer | HP | 8 | 1857 | 6 | 0.7500 |
| HP ISS | HEWLETT | 10 | 43 | 5 | 0.5000 |
| | PACKARD - | | | | |
| | PROLIANT | | | | |
| | SERVERS | | | | |
| HP Legacy | HP | 4 | 1857 | 3 | 0.7500 |
| HP | HP | 56 | 1857 | 45 | 0.8036 |
| NETWORKING | | | | | |
| HP | HEWLETT- | 24 | 473 | 12 | 0.5000 |
| NETWORKING | PACKARD | | | | |
| (3COM) | | | | | |
| HP ProCurve | HP | 25 | 56 | 25 | 1.0000 |
| | NET- | | | | |
| | WORKING | | | | |
| HP PROCURVE | HP | 7 | 24 | 6 | 0.8571 |
| H3C DISCOUNT J | NET- | | | | |
| | WORKING | | | | |
| | (3COM) | | | | |
| HP Server | HEWLETT | 46 | 90 | 41 | 0.8913 |
| Accessories | PACKARD - | | | | |
| | SERVER | | | | |
| | OPTIONS | | | | |
| HP Storage Media | HEWLETT | 24 | 688 | 15 | 0.6250 |
| | PACKARD | | | | |
| HP StorageWorks | HEWLETT | 38 | 69 | 34 | 0.8947 |
| | PACKARD - | | | | |
| | DAT 3C | | | | |

### Model Based Product Matching

Issues surrounding product matching and also UPC-based product matching are discussed at length above. However, not all of the system's data comes with a UPC code. For that reason, some embodiments may implement other product-matching techniques in place of or in addition to product matching and also UPC-based product matching. Below is described one such model-based product matching approach, which uses the model name (“MPN”) to match products. About 60% of all product records come with a model name, and about 40% of those products do not have a UPC, which makes model-based matching a promising complementary approach to UPC-based matching.

The basic approach to model-based matching is similar to UPC-based product matching: If two products have the same model name, they are likely to be the same product and can be matched. This description is an over-simplification, however. There are at least three challenges to be addressed when implementing model-based product matching:
Model name ambiguity
Noise in model data
Interaction with UPC-based matching
   The three issues are discussed below.

### Model Ambiguity (Model Homonyms)

Even if the system's data were 100% clean, model ambiguity would still be an issue when matching products. A model name is ambiguous (is an ‘homonym’) if two absolutely different products share that name.

It's probably safe to assume that a single manufacturer is not going to use the same model name (MPN) for two different products (but see “Dealing with noisy data,” below). It is also likely that two products from different manufacturers in the same product category are not going to have the same model name. At the same time, different retailers in different categories can quite possibly use the same model name, especially, if the model name is only a number. For example, ‘19205’ is the model number of Travelon headphones but it is also a scrapbook album.

In some embodiments, many invalid product matches due to ambiguous model names can be avoided by only matching products within the same category. Obviously, that approach requires product categorization, which depends on product matching, so there is a chicken and egg problem. Still, some product categorization can be done according to UPC-based product matching. As a result, some homonym matches can be filtered early on.

Similarly, brand (manufacturer) data can be used to detect model homonyms. Unfortunately, in many cases, manufacturer data suffers from the same problems as model data: It has to be cleaned and normalized (matched) first to be useful. (See discussion above.)

In some embodiments, model homonyms may be robustly identified using UPCs. Since UPC data can be cleaned, different products that have the same model name can be identified relatively easily. As a result, that model name can be filtered out from product matching. One caveat is that a single product can sometimes have multiple UPCs. In such cases, UPC-based filtering could miss out on some valid model-based product matchings.

In addition to model name ambiguity, there may also be noise in model data. Model names can be misspelled, shortened, etc. The same model name can be used incorrectly for multiple products. All this noise further complicates model-based matching.

In some embodiments, model normalization (described herein) can be used to help fix at least some incorrect model names. In addition, in some embodiments, fuzzy model matching combined with brand/category matching can be used.

Some embodiments can detect incorrect model data when two different products from the same retailer have the same model name. In such cases, the model name is frequently either invalid or meaningless. For example, computer memory upgrades from All4Memory often specify the computer model as the model of the memory upgrade. As a result, 1 GB, 2 GB, 4 GB, etc upgrades all have the same model name. In such cases, may be best not to use model data for product matching.

### Combining UPC and Model-Based Matching

The result of a product matching is essentially a set of products {p1, . . . , pN} that are considered identical. Since UPC-based product matching identifies products by a UPC, and a product is assumed to have at most one UPC, model-based matching should not match two products from non-trivial matched product sets {p1, . . . pN} and {q1, . . . , qM}. Indeed, each of the two UPC-matched sets would correspond to a unique UPC. Thus, the two sets should not represent a single product. It follows that if products pi and qj are model-matched, either pi or qj is a ‘singleton’ (it doesn't have a UPC-matching product).

### PRODUCT MAPPING.

In one test on an embodiment, a model-based matcher adds about 50,000 matched products to the set of 200,000 products matched by the UPC-based matcher. In accordance with at least one embodiment, model-based matching also covers 20,000 products from the retailer Newegg (most Newegg products do not currently have a UPC).

In accordance with at least one embodiment, the model-based matcher may take about 5 minutes to run on a set of two million products. In some embodiments, it may be desirable to run the UPC-based matcher before the model-based matcher.

One subtlety the model-based matcher has to deal with is updating product mappings (e.g., changing the unique_product_id of already mapped products). In accordance with at least one embodiment, the model-based matcher maps all of the products in any given model-matched set into a representative product(s) with a UPC, if there is one. Since model-matching of products with different UPCs is not allowed in many embodiments, this step is deterministic. In such embodiments, if none of the products in the match set have a UPC, the maximum unique_product_id in the model-matched product set is chosen as the new representative. This case is also deterministic.

In addition, some embodiments preserve old unique_product_id's for the re-mapped products. In accordance with at least one embodiment, such preservation is accomplished by maintaining a remapped_id reference associated with each unique_product_id that points to the new unique_record. Table 8 shows data for an illustration. Suppose after UPC-based matching the following records exist in two tables historical_products (the product offer table), and unique_products (a table storing information associated with unique_product_ids:

TABLE 8

| historical_products | unique_products |
|---|---|
| <id, model, upid> | <id, UPC> |
| HP1, A, UP1 | UP1, — |
| HP2, A, UP2 | UP2, 123 |
| HP3, modelA, UP2 | UP3, — |
| HP4, modelA, UP3 | |

In some embodiments, model-based matching would match products HP1 and HP2, and also products HP3 and HP4. Notice that UP1 which is the unique version of HP1 doesn't have a UPC and neither does HP4. In some embodiments, these products cannot have UPCs since model-based matching does not match products with different UPCs. (If HP1 and HP2 had the same UPC, they would have been matched by the UPC-based matcher).

Following the product mapping rules, HP1 will be re-mapped to UP2 (via the model match with HP2) and HP4 will be re-mapped to UP2 via HP3, as shown in Table 9

TABLE 9

| historical_products | unique_products |
|---|---|
| <id, model, upid> | < id, UPC, remapped_id > |
| HP1, A, UP2 | UP1, —, UP2 |
| HP2, A, UP2 | UP2, 123 |
| HP3, modelA, UP2 | UP3, —, UP2 |
| HP4, modelA, UP2 | |

Notice that the unique_products UP1 and UP3 are now ‘orphans’ since they don't have a parent historical_product. After this re-mapping stage, a new representative product can be selected among the bigger set of matched products.

### Additional and Alternate Approaches

In addition, or alternate, to UPC/GTIN based matching and brand/model based matching, product matching in accordance with at least one embodiment of the invention may be based at least in part on technical specifications, offer titles and descriptions (e.g., model names and technical specifications extracted therefrom), retailer identifiers and/or SKUs, and/or merchant “channels” (e.g., web pages with a standardized format) including pre-matched offer data.

### Pre- and Post-Validation

In some embodiments, the unique_products table or equivalent representation of unique_product_id information may be significant for a variety of services because losing product mappings can result in incorrect products linked to previously published links. As a result, some embodiments may be diligent about maintaining unique_products.

In accordance with at least one embodiment, before running a daily matching job, the validity of the data may be verified by checking for dangling or NULL references in both unique_products and historical_products. If no bad references are found, unique_tables may be saved to a file. After that, matching can be done. Final post-validation may be performed at the end similarly to pre-validation.

Purchase Timing Recommendations from Price Predictions

In accordance with at least one embodiment of the invention, matched offer data, product price histories and other input data may be utilized to build a prediction model to help consumers make a better purchase decision. Machine-Learning techniques may be utilized to generate one or more of the following predictions:
1) A “buy” or “wait” recommendation—A goal of this recommendation is to maximize the expected savings by a consumer receiving the recommendation. For example, a user following the recommendation may expect to save, on average, between 5% and 15% of the product price within the next 30 days.
2) An ‘arrow’ corresponding to a forecast price movement—A purpose of this information is to help the consumer understand the likely scenarios with respect to the product's price. For example, a “wait” recommendation combined with a down price prediction may provide a stronger signal (e.g., be associated with a higher confidence) to wait for a price drop relative to the “wait” recommendation alone. On the other hand, a “wait” recommendation combined with a down-or-flat price prediction may provide a weaker signal and/or be associated with a lower confidence. For example, the accuracy of arrow predictions may be greater than 75%.
3) Arrow prediction confidence—e.g., a confidence score associated with the arrow prediction.
4) Price change estimates—Price change estimates provide additional information with respect to the arrow prediction. While an arrow prediction tells the consumer which way the price is likely to go, a price change estimate specifies the likely range of the price action.

The price prediction algorithms described above may utilize historical offer data to build prediction models. Real-time offer data may be utilized as inputs to the prediction models to make real-time predictions. In both cases the data may be preprocessed. Individual merchant offers may be matched with a corresponding product as described above. Matched offer data may be used to compute product-level aggregates of price behavior. Some examples of such aggregates are the current lowest offer price for the product, the lowest/highest price over the last 30 days, the number of merchants offering the product right now and over the last 30 days, etc. These aggregates may be utilized by the prediction system as prediction attributes.

In various embodiments, features used by the prediction models include:
1) current price;
2) difference between current price and recent average;
3) historical volatility for the product;
4) historical volatility for the brand;
5) number of sellers that are selling the product;
6) number of days since the product was released;
7) whether the product is in stock or not;
8) whether certain merchants are carrying the product or not; and
9) seasonal considerations.
10) Popularity of the product
11) release date/where product is in its lifecycle

In accordance with at least one embodiment of the invention, release dates may be used to improve price prediction accuracy. Consumer products, especially electronics items, can go through life cycles which determine consumer demand, manufacturer supply, and store availability of products. Such variables can affect price behavior. However, product release dates are not always available. In addition, available data is often invalid or inconsistent across sellers and data channels. A release date discovery system in accordance with at least one embodiment of the invention may aggregate release dates from different channels and available product review dates to estimate the most likely range of release dates for a given product. The middle point of this date range, for example, may then be fed into the price prediction subsystem as a product attribute.

### Predicting Future Price Movements

Probability of a price change over a fixed interval—In many embodiments, one of the basic prediction problems is predicting the probability that a price will rise or drop by more than a fixed percent over an interval of time. One example is predicting whether the price will drop more than 5% in the next two weeks. Various embodiments model this problem as a classification problem where the training data comprises sequences of prices for the unit of prediction of interest (e.g. product offered by single merchant, lowest price among all merchants, and the like). Various embodiments can then apply any number of classification algorithms that are capable of producing probability scores. Examples include random forests, logistic boosting, logistic regression, and the like.

In accordance with at least one embodiment of the invention, the price prediction component may build three machine-learning models for predicting (i) increasing (UP arrow), (ii) steady (FLAT arrow), and (iii) decreasing (DOWN arrow) prices. For example, the models may use a minimum of $50 or 5% of the product price as a price change threshold. For example, the UP model tries to predict if the price is going to spike up by that amount or more without ever dropping down within the 30 day prediction time window. Similarly, the DOWN model predicts that the price will drop at least once by $50 or 5% without spiking up. Finally, the FLAT model predicts that the price will stay within the smallest of $50 or 5% for the entire prediction window. In accordance with at least one embodiment, the predicted probabilities for the 3 arrows are a proper probability distribution and are normalized to sum to 1.

Table 10, below, shows a number of performance numbers for predicting whether a price drop will occur over a fixed time interval in accordance with at least one embodiment.

TABLE 10

| | drop | time | | % | | | |
|---|---|---|---|---|---|---|---|
| cat | threshold | interval | drop % | predicted | precision | recall | accuracy |
| TV | 5%/$50 | 14 days | 35.5% | 21.6% | 74% | 45% | 75% |
| TV | 10$/$100 | 14 days | 20.7% | 9.7% | 77% | 36% | 84.5% |
| TV | 5%/$50 | 28 days | 38.75% | 30% | 64% | 50% | 70% |
| TV | 10%/$100 | 28 days | 23.4% | 13.9% | 66.6% | 39.5% | 81.2% |
| laptops | 5%/$50 | 14 days | 22% | 6% | 61.4% | 17.1% | 79.5% |
| laptops | 10%/$100 | 14 days | 7% | 1.6% | 69.6% | 16% | 94% |
| laptops | 5%/$50 | 28 days | 32.3% | 20.5% | 56.7% | 36% | 70.3% |
| laptops | 10%/$100 | 28 days | 12.1% | 3% | 66% | 16% | 89% |
| camera | 5%/$50 | 14 days | 31% | 19.6% | 69.7% | 44% | 76.6% |
| camera | 10%/$100 | 14 days | 15.2% | 8% | 68.6% | 36.4% | 87.8% |
| camera | 5%/$50 | 28 days | 42.6% | 39% | 67% | 61% | 70.6% |
| camera | 10%/$100 | 28 days | 21% | 13% | 65% | 40% | 82% |

Conditional probability distribution of potential price changes over a fixed interval—In some embodiments, the conditional probability distribution of the potential price change over a fixed period of time is modeled by creating several different classification problems. In accordance with at least one embodiment, each individual classification problem corresponds to predicting the probability of price change greater than a fixed threshold over the interval. Predictions can be created for several different fixed thresholds, and interpolated to calculate the probability of an arbitrary price change over a fixed interval.

### Incorporating Local Tax Info in Price Predictions

In accordance with at least one embodiment, the general algorithm described in the previous section may be utilized to make price direction predictions that incorporate the impact of local taxes.

In accordance with at least one embodiment of the invention, the effective tax rate for price predictions can be determined automatically in most cases using the reverse-IP technology or it can be provided by the user. When the tax rate is known, the prediction system may use the price with tax to make a price drop prediction for each merchant offering a product. The required price drop for each merchant may be adjusted for the merchant's tax.

Once the system estimates the price drop probabilities for each merchant, another prediction model may be used to aggregate these probabilities into the final probability of a price drop. In many situations, the probabilities cannot be simply added up, for example, when merchants publish their offerings through multiple channels. Merchant offers may be “correlated”, so that a separate prediction model is properly used to combine offer-level predictions. In accordance with at least one embodiment of the invention, a machine learning algorithm may be utilized to determine combined offer level predictions from individual product predictions. This algorithm can be thought of as a variant of the stacking algorithm. During the training phase, the classifiers for the individual product predictions are first trained via cross validation, then applied to the products to generate scores for each product. A new training set is then created where each record contains all the product scores belonging to the same group. In accordance with one embodiment, linear regression with higher order interaction terms, passed through a sigmoid function, and trained via stochastic gradient descent is used.

Generating Price Predictions for a Group from Predictions for Individual Members

In many situations, it may be desirable to predict how an aggregate of the price from a group of items might change over time. There are many reasons why this might be useful.

For example, even if a user is interested in the minimum price for a product among a group of merchants, differences in shipping and sales tax, makes the true price for a single merchant differ based on where the customer is located. Consequently, in some embodiments, it may be difficult to track many informative features, such as the history of minimum prices accurately, since many features depend on the customer. In some embodiments, this problem may be addressed (at least in part) by making a prediction for how the base price of a product might change for individual merchants, factoring in runtime factors (e.g., shipping, taxes, coupons, and the like) afterwards to create a final prediction.

Also some customers might be only interested in certain merchants offering a product. In some embodiments, predictions may be created based (at least in part) on how the average or minimum price among subsets of merchants offering the product may change over time.

Also, some customers might find a group of products that they might be interested in choosing between. In some embodiments, predictions may be created based (at least in part) on how the average or minimum price among the group might change over time.

The method used to solve this problem for local tax computations described above is an example of a more general approach to solving these problems via stacking:
1) Train a classifier for producing a conditional probability distribution of price drop/rise for individual products and use them to generate the conditional probability distribution per product;
2) Calculate features based on the conditional probability distribution and price for each element; and
3) Train a classifier to predict whether the aggregate price from the group of items rises/drops based on the features derived in step 2.

### Buy/Wait Recommendation Model.

Making Buy/Wait recommendations—A buy/wait recommendation is a different problem than making a pure prediction about a price change. The difference primarily lies in the fact that the recommendation is an actual action that a customer can follow. In some embodiments, the customer may not care just about whether an individual price prediction is accurate. Rather, the customer may case about whether he or she will save money by following the predictions and recommendations. Consequently, in some embodiments, a simple buy/wait recommendation may be of value to the customer. Various embodiments may evaluate the quality of these recommendations by whether the customer saves money and how long it took for the customer to realize these savings. In accordance with at least one embodiment, the time of waiting may be evaluated versus dollars saved by explicitly assigning a dollar cost for each day that the customer needs to wait to buy a product. If the amount the customer saves is less than the cost of waiting, then the wait decisions were good ones. In the shopping domain, where prices will always drop in the long run, this waiting penalty may be a desirable factor in assessing reasonable recommendations.

In various embodiments, different approaches may be taken towards making these buy/wait recommendations. In accordance with at least one embodiment, rules may be created that determine when a situation warrants buying or waiting, based on a set of price direction predictions. For example, one embodiment might recommend a customer wait if there is a high chance of a price drop, and the expected price over the next few weeks is close to or less than the current price. This means that there is both the opportunity to save money, and not too much risk if the customer doesn't catch the exact lowest price drop.

Another embodiment may create a policy for buy/wait decisions based on a cost-sensitive classifier where the desired prediction is WAIT when the cost of BUYING=0 and cost of WAITING=profit—penalty for length of waiting period.

Another embodiment may create a policy for buy/wait decisions that is explicitly optimized to maximize the reward for a customer over a set of training data. Such an embodiment may develop algorithms based on reinforcement learning and sequential decision making for this purpose. For example, such algorithms may have the following form:

a. Create an initial training dataset for learning Buy vs. Wait;

b. Let Policy<=Train be a cost sensitive classifier on the dataset; and

c. Loop over:
i. Apply policy to dataset to create new training data;
ii. Set Classifier=Train cost sensitive classifier on new dataset; and
iii. Set Policy=(1−a)*Policy+a*Classifier, where ‘a’ is a blending parameter.
   Example algorithms that fit this bill are the Seam algorithm, or other suitable algorithms for approximate policy iteration utilizing suitably modern classifiers.

In the unlikely event that the arrow prediction contradicts to the buy/wait recommendation, the two predictions may be adjusted to be consistent based on the prediction confidence.

### Price Change Model.

In accordance with at least one embodiment of the invention, price changes may be estimated with a quantile (median) learning algorithm. The resulting model predicts the median price move. Two such models may be constructed: one to predict the median price rise and another for the median price drop. The final price range between the two medians may inform the user about the likely price extremes.

Extracting Current/Future Product Information from Free-Form Text

With the proliferation of online news sites, product rumor site, deal sites, blogs, and web forums, there is an increasing amount of information available on the World Wide Web (WWW or “web”) about current and upcoming products. In this description these announcements, web pages, posts, and the like may be collectively referred to as “articles”. Such articles may contain official announcements of new product, unofficial rumors about upcoming products, reviews, rebates, updates, or recalls of existing products, or more general information that can affect pricing or new model recommendations, or more otherwise influence a buy/wait purchase recommendation.

There is often a substantial amount of information available in these articles, but this information is typically designed to be read by people, and is therefore presented in natural language and/or free-form text, in contrast to a machine readable and/or deliberately structured format. For example, consider an article from Feb. 7, 2011 announcing an upcoming Canon camera:
“Today Canon announced the Rebel T3i, an update to its popular EOS Rebel series of cameras. As an updated version of the Canon Rebel T2i announced last year, the Canon Rebel T3i incorporates the same 18.0 Megapixel APS-C size CMOS sensor, and the same DIGIC 4 image processor, capturing images at up to ISO 12800 and speeds of up to 3.7 fps. The Canon EOS T3i Digital SLR camera is scheduled to be available by the beginning of March, and will be sold in a body-only configuration at an estimated retail price of $899.99.”

This article contains a wealth of information about release date ranges, predecessor/successor relations, pricing information, and product features. This information can be useful for informing model predictions, price predictions, and for making more general purchase recommendations.

However, automatically identifying and extracting this information is challenging for several reasons, including:
1) Not all articles are about products, so a system must determine which ones are likely to be relevant versus which ones aren't.
2) The information is typically presented in free-form, natural-language text. A system needs to identify and extract the relevant pieces and convert them into a normalized form.
3) Identifying which products an article is likely to be relevant to, and the reasons for that. E.g., an article may be relevant due to describing a known product, due to describing a successor of a known product, due to describing similar/competing products, etc.
4) Many articles are unreliable, containing incorrect or misleading information, so a system must decide how confident it is in the information within the article.

In accordance with at least one embodiment of the invention, each article may be processed in a sequence of steps, with the output of each step being used as the input of the next step. For example, in at least one embodiment of the invention, a system may first attempt to classify each document as being likely to contain information about to at least one known product, it may then run a sequence of information extraction techniques to identify the broad category(ies) of the article, the manufacturer of the product, the name of the product, the price, features, release date, etc. of the product, the relevant predecessor products, and the reliability of the information within the article. In this case, we would like a system to identify the article as being about the release of a new camera, manufactured by Canon, with name T3i, which is the successor of the T2i, retailing for $899.99, being released in early March 2011, and having an 18-megapixel cmos sensor, etc. Furthermore, since this based on an official press release from the company, we would expect the information in it to be highly reliable. We provide examples of performing each of these steps in turn.

### Identifying Interesting Articles

Potentially relevant articles may be identified in many ways. For example, many companies list press releases on their websites which describe existing or upcoming products. There are many websites, blogs, and forums which are devoted to discussions of particular products (e.g. MacRumors.com is dedicated to information about Apple products). Many of these websites provide a feed describing recently published articles, which can then be downloaded and processed. Alternatively, these sites may be “scraped”, by automatically identifying, following, and downloading articles linked from pages within the site. Additionally, relevant pages may be identified using a web search engine by searching for key terms and downloading the returned articles.

It is often useful to pre-filter these articles to select the ones which are likely to contain useful information of a particular type and eliminate those which are not likely to be useful. For example, we may want to process articles describing sales/rebates of products differently from articles officially announcing new products or providing unofficial rumors of upcoming products. To automate this process, we can train a machine learning classifier, that will take as input features of the article such as the title of the article, words in the article, the source of the article, etc. and which will output a confidence score determining whether the article is likely to contain information useful for predicting model releases, price changes, or otherwise affect a purchase recommendation.

Training data for such a classifier may be manually labeled by a human annotator, or it may be labeled heuristically based on key phrases/patterns (e.g. “Canon announced”, “rumored update to the XXX”, etc.) or historical observations (e.g. an article mentioning a sale on a known product and then observing a price drop for that product). Given a collection of labeled articles, we can train a machine learning classifier such as a Naive Bayes classifier or a Support Vector Machine classifier that will be able to compute a confidence score reflecting how likely any article is to contain useful information of any given type. This classification may then be used to determine how information in the article can be identified and used.

Information Extraction from Text

Articles are typically in natural-language, free-form text. To make use of the information contained within them in an automated system it must first identify, extract, and normalize the relevant information from within the articles. Information that we want to identify within an article includes the names of any products mentioned within an article, their manufacturers, family lines, prices, features, and potential release dates.

However, identifying this information is challenging, since the same fact can be expressed in a multitude of ways. For example, a description of a release date as “the beginning of March”, may just as easily have been expressed as “early March”, “the first week of March”, “before mid-March”, etc. Similarly, the camera type of “Digital SLR” may be written as “D-SLR”, “dslr”, or “digital single-lens reflex”.

We can use a number of techniques to identify and normalize the salient features. For attributes with a relatively small number of known values (e.g. product manufacturer, product category, product type), we may use a simple dictionary that maps known words to a normalized form. Such a dictionary may be constructed manually or by using automated methods such as the brand-cleaning techniques described above.

More complex attributes may be discovered using manually constructed or automatically learned extraction patterns. For example, “$” followed by a number typically indicates a price or a discount amount, depending on the article type, or “available by the beginning of <Month name>” indicates a potential release time frame. These patterns typically take the form of one or more “blank slots” indicating the target property(ies) to be extracted, surrounded by a phrase or regular expression indicating in what sentences that extraction should be applied.

Additionally, more complex information extractors, such as Conditional Random Field methods, may be trained using labeled data to extract features such as family or model names, or other desired. These more complex extractors may use previously extracted properties, properties about the potential word to be extracted, properties about surrounding words, information about other occurrences of the word in the article, etc. For example, to identify “Rebel” as a likely family name from the phrase “Canon Rebel T3i” such an extractor may make use of the fact that the preceding word is a manufacturer name, the word in question is capitalized, and the following word contains both letters and numbers, among other things. A system may train such an extractor using manually specified labels, heuristically labeled data, or “bootstrapping” labels by iteratively extracting some features from the article, using those to identify potentially matched products (as described below), then using known features of the matched products to identify and label additional training examples within the article, retraining and rerun the extractors, and using the more complete set of features to better identify matched products.

Additionally training data for information extraction algorithms, like those described in the previous paragraph, may be created from external sources of data. For example, we often have access to technical specifications for products along with text associated with the product such as reviews, titles, and descriptions. We can label phrases in the text that directly correspond to the technical specifications and use that as training data for our information extractors.

Finally, a system needs to normalize the extracted properties so that they may be properly utilized and compared to other articles or products. For numeric attributes this may involve converting to a standard unit (e.g. converting gigabytes of ram to bytes of ram, converting screen size from centimeters to inches, etc.) For other attributes this may mean simply mapping into a known lexicon (e.g. manufacturer name). However, in some cases additional processing may be required. The most compelling example in this instance is normalizing a release date range to an appropriate range over specific years, months, and days. In the above example, we would like to normalize “available by the beginning of March” to be the date range from Feb. 7, 2011 through Mar. 1, 2011. To do so, a system may make use of a variety of properties of the article including the publication date of the article (if known), any other dates mentioned in the article, the tense of words within the article, or release dates of any other products matched to the article. A model for resolving the time frame mentioned in an article may be constructed using a set of heuristics (e.g. “last year” means the year before the article was published, future tense phrases such as “will be released in March” indicate a future date, but one within a year of the article's publication date). Alternatively, such a model trained from some labeled data about known dates mentioned in articles using machine learning techniques, by taking into account features such as word tense, other dates in the article, etc.

Associating Text with Products or Product Successors

We next want to determine which product(s) an article is relevant to, and the article is related to the product. An article may be relevant to a product either through a direct relationship (the article is about this or similar products), or through a successor relationship (the article is describing a successor for an existing product).

We may use commonalities between a product and the properties extracted from an article, as well between the product and as the article itself, to determine which products it is relevant to. In the simplest example, the more times an article mentions a product by name, the more likely the article is to be relevant to that product. In the above example, the article mentions the “Rebel T3i” several times, so if/when the T3i camera exists in the catalog that article is likely to be very relevant. Similarly, it mentions the “Rebel T2i” once, so there it is fairly likely that the article is somehow relevant to the T2i camera as well.

More generally, we can learn a model that utilizes commonalities between the extracted features and a product to determine the type and strength of relation between an article and the product (direct, successor, no-relation). Properties which are useful for determining the relationship include the category, manufacturers, price, model number, family line, similarity between the model number and an existing model number (e.g. T3i and T2i are “close” to each other in terms of relative edit distance, whereas T3i and S95 are not), similarity between the product's features and extracted features, and the classification of the article. Training data for such a model may be manually created, or it may be bootstrapped by starting with highly selective features to get an initial set of labeled relations for a set of (product, article) pairs, and then iterating between training a model to determine relations, and using that model to label (product, article) pairs with their likely relation. For example, an initial set of direct-relation examples may be created by requiring at least 3 exact matches of a model name within an article. A set of successor-relation examples may be created by requiring that the article is classified as an “official product announcement” or an “unofficial product rumor”, the product's name is mentioned between one and three times in the article, and that the product was released at least 6 months before the article was written. Finally a set of no-relation examples may be created by requiring that the product has a different manufacturer, dissimilar model name, and/or substantially different price.

### Purchase Timing Recommendations Based on Text

These articles, the information extracted from them, and the identified relations they have to existing products may be used to influence purchase timing recommendations in different ways including (1) predictions on when new models will be released, (2) predicting future price changes, and (3) more generally purchase recommendations (e.g. finding problems with products that make them less attractive)

As an example, if an article is found to have a successor relation to an existing product, then the potential release time-frame extracted from the article (if it is mentioned) can influence a prediction of whether or not a new model is likely to be released within a given time frame. In the above example, we can use the fact that there was an official press release indicating that a successor to the Rebel T2i will be released by March, 2011 to significantly increase the prediction confidence of a successor product being released between the article's publication date (Feb. 7, 2011) and Mar. 1, 2011.

However, not all articles contain reliable information, and not all information within an article may be reliably extracted. The degree to which a system trusts the information in an article and uses it to influence predictions or purchase recommendations depends on both the reliability of the source as well as the confidence it has in the individual extractions from the article. For example, an official press release from a manufacturer is likely to contain very reliable information, and is likely to use grammatically correct and fairly standard language, making it more likely that the information would be correctly extracted. As such, a system may have high confidence in the information from the article, and so may allow it to strongly influence predictions. On the other hand, unofficial rumors (e.g. rumors surrounding Apple's next iPhone) sometimes contain correct information, but sometimes to not. As such, lower quality information should influence predictions to a lesser degree.

To judge the quality of the information extracted from the article, a system should consider at least three factors: the confidence that the article contains reliable information, the confidence that the individual extractions were identified and normalized correctly, and the confidence or strength of the identified article-product relationship.

The confidence in each individual extraction or the relationship may in some cases by provided by a machine learned model, and/or it may be estimated based on historical data. Factors which influence these confidence estimates include the grammatical quality of the article, how many times a similar extraction/relation has been identified historically and how many times it was correct, and how many articles from other sources were published around the same time with similar information.

The confidence that an article contains reliable information is also an important factor. It may be influenced by a variety of factors, including the source of the article (e.g. company press pages are more reliable than web forums), the type of the article (e.g. official announcements are more reliable than unofficial rumors), the spelling and grammatical structure within the article (e.g. web forum posts with many misspelled words are more likely to be speculation, rather than reliable information), how many and what other sources link to or describe the same article (10 news sites linking to a product announcement is a strong vote of confidence that the article contains reliable information), and time frames or other properties extracted from the relation (e.g. a rumor about a product coming out in 2011 is probably not as reliable as one which considers a narrower window of March, 2011). To estimate the confidence that an article contains reliable information, we may train a machine learning model using historical data of articles and whether the information turned out ultimately to be correct. This training data may be manually labeled, or it may be generated by examining historical articles and determining whether the events described took place. In the above example, we can observe whether a successor to the Rebel T2i was released in the given time period, and use that as a positive/negative training example depending on whether a successor was released or not.

The confidence in the reliability of the article, the individual extractions, and the identified product relations may individually or together affect various predictions in a larger system. They may either be including as additional factors in the models used by a prediction/recommendation system, or they may be combined with the predictions directly using Bayesian techniques.

Although the primary example discussed in this section involved a new model prediction, these articles and information extracted from them may be used in other was as well. For example, an article announcing a sale or rebate for a particular, existing product may be used to influence whether the price of that product will go up/down. Additionally, an article describing a flaw or a recall of an existing product may be used directly to recommend against purchasing a particular product. In all of these cases, the predictions/recommendations may be affected by the reliability of the article, the information extracted from the article, and identifying the relationship(s) identified between an article and product(s).

Predicting Future Release Dates from Historical Data

In some embodiments, recording accurate statistics on the release past models by each manufacturer will enable the system to anticipate model releases. In various embodiments, factors that could affect new-model predictions may include some or all of the following:
Manufacturer;
Season;
New model history (e.g., a new models are typically released before the Super bowl);
Relevant events (e.g., new models are released at MacWorld);
Models released (or announced) by competitors.

In one embodiment of the invention we have access to:
1) A set of curated timelines that shows models and their release dates. The co-existence of two models in a timeline mean that the models are past/future versions of each other; and
2) A mapping from matched products in our data to models in the timeline.
   Given this data, we can construct training data for a supervised classification algorithm for predicting when new model releases come out. Each record in the training data corresponds to a model at a single point in time, and the target variable derived from when the next version of the model was released. Any modern classification algorithm can be utilized to create a predictor for future releases from this data.

One element of model release prediction is determining which models are different versions of each other. To achieve this, some embodiments may utilize brand and title similarity information, along with release dates to find possible different versions of the same model. Some embodiments may search for possible groups of products that are different versions of each other and rely on human curation to filter down the candidate list to a final list. Other embodiments may cast this as a classification problem where the input is information about two products that are possible alternate versions of each other, and the prediction is whether the two are or are not alternate versions of each other.

### Automated Construction of Product Time Lines.

In order to train classifiers to create predictions for future releases from past model timelines, we need to create training data that partitions products into timelines. This can be a labor intensive process, so in accordance with at least one embodiment of the invention, the evolution of products over time may be represented, visualized and predicted in an automatic fashion via a graph of ancestor/descendant relationships between products. Examples of product evolution include specific evolution of models that a manufacturer produces over time. For example, the D70 camera is followed by the D80 and then the D90. However, product evolution can be more general and take into account more qualitative tags such as “products similar to the current product the customer is browsing” in a shopping engine, or products that are tagged with soft labels such as “gaming laptops.” Product time lines may be created automatically and semi-automatically from this graph.

The input to the timeline constructor system in accordance with at least one embodiment of the invention may include a list of products along with the following information:
1) product names and descriptions (e.g., plain text);
2) dates such as published/release dates from merchants, and review dates;
3) structured product specifications (e.g., scraped or from merchant feeds); and
4) manually curated data related to the above (e.g. manually researched release fates, explicit assignment of products to model numbers).

The output may include components such as:
1) a product graph recording the ancestor/descendant relationship between different products; and
2) a product lineage, which may correspond to a linear depiction of the history of a product's evolution.
   The process of constructing product time lines may include some or all of the following steps:
1) Extracting relevant attributes of products;
2) Collection and estimation of product release dates;
3) Estimating specification quality;
4) Generating a graph of ancestor/descendant relationships between products based on hard constraints on allowable relationships; and
5) For each product, constructing path through the graph containing the product. The choice of which ancestors or descendants to include are determined by a ranking function, and potential constraints on time allowed between points on the timeline.

### Extracting Relevant Attributes of Products

A goal of this step is to take various sources of data from which relevant information about a product may be extracted, and then to turn that into a standardized structured representation that the rest of the system can use. Examples include:
1) structured product specifications;
2) unstructured product titles, and descriptions;
3) news articles, wikipedia, or external sources of data;
4) manually labeled data; and
5) product pricing data.

Another goal is to extract relevant attributes about products. Such attributes include:
1) technical specifications;
2) family line & model number;
3) explicit grouping of products into clusters;
4) price; and
5) explicit taggings (e.g. “easy-to-use”, “high end”).

Strategies for generating structured specifications include:
1) Direct translation: where pre-existing structured specifications are available.
2) Pattern based: several strategies may be combined to generate high quality information with respect to model numbers, model series, and model release dates. For example, a set of patterns may be determined that extract snippets of text from product titles that look like model numbers. Such text snippets may be mapped to a table of cleaned model numbers, and for each model number, relevant information such as release date, family line, and model series may be manually assigned. A database that maps model-name snippets to a fixed number of model series where model series are predefined manually may be maintained. Model snippets may be extracted from titles with pattern matching. For new model snippets that don't already appear in the database, a new entry may be manually assigned to a model series.
3) Automatically from text: In accordance with at least one embodiment of the invention, it is possible to automatically extract specification values from unstructured text that has been collected relating to a product. These range from technical specifications like screen size to model names and brands. Such automatic extraction may be implemented based on a set of hand-crafted regular expressions and/or via machine learning where classifiers are built for each desired specification value based on training data from product titles and descriptions with known specification values.

### Generating Likely Release Dates for Products

In accordance with at least one embodiment of the invention, another goal is to compute likely bounds on a release date of products given information collected relating to their release from various merchants, when reviews occur, and/or when data collection with respect to the product first began.

Inputs to this computation include a set of potential release dates gathered in step 1. Such dates include:
1) A set of relatively accurate, manually curated release dates for a portion of the product catalog; and
2) Less accurate release date information that can be efficiently collected. Such release data information may be available for the majority of the product catalog. This includes release dates reported by merchants, review dates, and dates products appeared in monitored feeds.

Outputs of this computation include a probability distribution over probable release dates for some and/or all products in the catalog. For products for which more evidence has been collected will have tighter bounds on the interval of time including the probable release dates.

Relatively accurate curated release dates can come from a number of sources. For example, in some model lineages, release dates for products may be based on the release date of the base model for a product.

To construct a conditional probability distribution learner, a series of quantile regression problems for a set of quantiles q1, q2, . . . qn may be created. A goal the qi quantile regression problem is to predict a date for a given product such that the probability the product was released after the predicted date is at most qi. Given the set of regressors, the probability that a product was released before a date may be determined with the following algorithm:
1) for each regressor q1 . . . qn, predict the dates d1 . . . dn; and
2) for the date in question, find the interval di . . . dj within which the date falls, and linearly interpolate the corresponding quantiles.
   The date associated with an arbitrary quantile can be determined in a corresponding manner. To compute the likelihood that product A was released after product B, by a given time interval, the corresponding cumulative distribution functions may be integrated and subtracted from one another.
   Automated Evaluation of Product Quality from Specs

In accordance with at least one embodiment of the invention, a criterion for determining product timelines is product quality, in terms of capabilities. In general, if product A is a descendant of product B, then A should have more/better capabilities than B. Consequently, evaluation of product quality/capabilities can play an important part in building product timelines.

In accordance with at least one embodiment of the invention, product quality may be estimated based on specifications of a product. Inputs include:
1) Product specifications; and/or
2) Product prices drawn from a most recent few months.
   A model may be produced that allows comparison of the relative quality of two products.

Such a model may correspond to a single regression problem that attempts to estimate the product price based on its specifications. However, the number of possible specifications may be relatively large compared to the number of products, and product records may lack significant specification information, which can compromise the accuracy of the estimator.

Alternately, or in addition, a series of models (e.g., for each type of product specification) may be constructed. A goal of such models is to order possible specification values by a degree to which they contribute to product quality. For example, higher quality specification values may have a higher score than lower quality ones. In accordance with at least one embodiment of the invention, such orderings may be obtained by creating a set of one-dimensional regression problems (e.g., one per specification type) where the input data are product specifications and the output data is the price of the product. In the end, each model learns the average price for products with a particular specification value. This average price can be utilized to order specification values (e.g., as a proxy for desirability). These learned mappings may also be utilized in a product history construction phase to filter out products where there is no evident improvement in quality. In addition these mappings may be utilized to highlight particular specifications that have changed between product generations.

### Model Names

Model names can provide a cue to the ordering of products. However, this is not always a reliable signal. For example, the Nikon D90 is followed by the D300s, D3000, and D5000. The logical successor is the D5000 and not either of the first two.

Model names may be utilized an additional feature when computing a similarity between two products. Similarities can be utilized to help rank products when deciding which products to include in a timeline.

Alternatively, or in addition, model names may be utilized to help cluster products. Products that share a common model name may be identified and/or designated as having a same release date. In addition, in some categories technical specifications are shared across products with a same model name. Model names may be utilized to propagate release dates and specs through a cluster of products.

### Create a Product Graph Based on Hard Constraints on Allowable Edges

A directed graph of ancestor/descendant relationships may be constructed in which each product is a node in the graph and each edge corresponds to one ancestor/descendant relationship. Inputs to this construction include:
1) product reference data such as:
   a. current and historical product prices;
   b. product specifications;
   c. product titles; and
   d. product model; and
2) trained product specification value model(s); and
3) the estimated probability distribution for the product's release date.

The product graph may be created by generating an edge for each product that satisfies a set of hard constraints. Such constraints can include one or more the following:
1) Time ordering: for example, newer products are released after older ones. This ordering can be established with curated release dates, and/or based on the probability distribution over release dates for each product.
2) Quality improvements: constraints with respect to whether the product has measurably improved in quality from one generation to the next.
3) Price point: constraints based on whether products are marketed at similar price points, and/or are currently at similar price points. For example if a new high quality item goes on sale at a very good price, it may be highlighted as an appropriate newer product in an older product's timeline.
4) Category specific rules or specification value constraints.

In many categories rules may be established, such that violation is a strong indication that two products should not be part of the same timeline. For example, point-and-shoot cameras and DSLR cameras should not be together. 22″ and 50″ TV's should not be together as well. Such rules may be encoded as hard constraints.

### Construct a Lineage

Once the product graph has been generated, one or multiple paths through the graph may be generated with a wide variety of graph search algorithms. Such algorithms typically rely on a notion that each edge in the product graph has a “weight” that corresponds to how appropriate it is to have the two products share the same timeline.

Inputs for lineage construction include:
1) Product reference data (e.g., prices, potential release dates, specs, and/or availability); and
2) The ancestor/descendant product graph.

Weights may be determined with a similarity function having input parameters including one or more of the following:
1) similarity between model names;
2) product popularity;
3) similarity of price points;
4) current product price relative to expected product price;
5) recency of product release; and
6) product availability, including number of sellers.

### Learning how to Construct Lineages

A weight function may be determined based on website criteria for linking products together in the lineage, for example, the weight function may be determined to optimize for drop-offs and/or number of clickthroughs.

A basic experimentation framework may be established within the model history service for collecting training data. The model history system can usually create a timeline using the current optimal weighting function, and occasionally with a more randomized weighting function. Given interaction logs, training data may be created for determining a model to predict expected clickthrough/dropoffs given properties of the edge between two products. Model history presentation to a user may be represented by a single training record where the target is a variable that represents whether the user performed the desired interaction. For clickthroughs may be attributed to a presented hyperlink. For dropoffs credit may be attributed to model history links that eventually lead to a dropoff (even if the user had to click through multiple links to get there) with credit propagation techniques used in reinforcement learning. The training system can run on a nightly basis and optimize the weight function for lineage construction over time.

Alternatively, or in addition, in categories with sufficient manually-determined lineages, the manually-determined lineages may be used as training data for a weight function that “fits” the manual lineages, but generalizes beyond them.

Predicting Future Releases from Automated Product Timelines

Predicting future product releases can be undertaken in the following way. For products that do not have an existing descendant, a goal is to predict whether a descendant of the product will appear in a time interval in the future. This contrasts with predicting whether a new product model will be released. Predictions may be performed with respect to unique products and at a given point in time. Such a technique may be advantages when model names are not necessarily the appropriate granularity with which to categorize products and when high quality release dates are not available. Here, the date when a product first appears in a feed may be utilized.

Input to the corresponding learning system may include:
1) an ancestor/descendant product graph;
2) other product attributes such as specifications, prices, potential release dates; and
3) aggregate statistics that can be generated from the graph such as average release cycle.

Training data may be generated for this prediction problem based on historical data in the following way:
1) A set of possible successors may be determined for each product in the database.
2) A train/test set may be created having one record per product. The target will be the minimum number of days between an observation date and the first date that a successor appears in the feed.
3) Time ranges for future product appearances may be predicted utilizing mechanisms similar to those described above for model lineage prediction.
   Once the training data has been generated, a suitable supervised learning algorithm may be applied to generate future release predictions.

An example will help illustrate data that may be collected, determined and/or generated as part of automated construction and prediction of product time lines in accordance with at least one embodiment of the invention. Consider the “Powershot G” series of digital cameras made by Canon. Suppose observations were made on Jul. 5, 2009, Sep. 20, 2009, Sep. 27, 2009 and Oct. 4, 2009 relating to forecasts of a new product in the series within 3, 1, 1 and greater than 6 months, respectively. Table 11 includes example data related to the observations.

TABLE 11

| | #Days | #Days | | #Related | #Related | Recent | |
|---|---|---|---|---|---|---|---|
| #Products | Since | Between | #Days | Series | Manufacture | Price | Obs |
| in Series | Release | Releases | Overdue | Releases | Releases | Drop? | date |
| 3 | 277 | 350 | −73 | 0 | 5 | No | 7/5 |
| 3 | 354 | 350 | 4 | 2 | 11 | Yes | 9/20 |
| 3 | 361 | 350 | 11 | 2 | 12 | Yes | 9/27 |
| 4 | 2 | 354 | −352 | 2 | 12 | No | 10/4 |

In this example, a new product in the series was released on Oct. 2, 2009, which is reflected in the number of products since last release and number of days since last release. Average days between releases and associated number of days overdue are also updated. The “#Related Series Releases” lists the number of times in past years that a series release has occurred within 30 days of the observation date. The “#Related Manufacturer Releases” lists the number of times in past years that the manufacturer has released a product in any related series (e.g., “Powershot A”) within 30 days of the observation date. “Recent Price Drop” shows whether there has been a drop in price of a most recent model within the last 30 days. This data may be utilized as input to determine confidence scores for the forecasts as described above. Similar data for related series products may also be utilized.

Given product series with known or estimated release dates, a collection of these observations may be computed. For example, we may make an observation once per week of all of these features for each product or series. For historical data, we also may observe whether a new product in the series was released within a certain timeframe relative to the observation date. These historical observations may be utilized as input to determine confidence scores for the forecasts of likely successor releases as described above.

For example, we may train one or more machine learning models to identify a likely range for a successor within the series, along with the confidence score for that forecast. In one embodiment, we may generate training data for predicting whether a successor will be released within a particular window of the observation date based on the known values of historical observations. For example, within one month/more than one month, within two months/more than two months, etc., To ensure that the model will not “cheat”, we must not use any of the observations within the target prediction window or since the most recent release in the series, as we do not yet know whether a new model was released within the target prediction window. For all of the observations we do know the ground truth of, we may provide them to a machine learning algorithm (e.g. a “Random Forrest” type algorithm) which can then compute a confidence score of how likely a successor is to be released within the target window. The confidence scores from these separate models may be combined to for a distribution over successor release dates. From this distribution, we may determine a distribution over successor release dates, as well as how confident the model is that a successor will be released within a particular timeframe.

The distribution over release dates may then be used to recommend “wait, a new model is likely to be released within the next N days”, or “buy, no new model is likely to be released within the next M days”, where N/M are chosen based on a combination of confidence scores over release dates, category, manufacturer, or model release frequency, user feedback examining how long people will be willing to wait for a successor, or other methods. For example, many people are willing to wait a 6+ months for a successor of a high-end camera, but not as long for a new television. These distinctions affect the overall purchase recommendation.

### Combining Release Date Predictions

We can make more accurate release date predictions by combining potential release dates extracted from text and historical data such as timelines generated from the automated lineage construction described previously. One method is to combine release date predictions made from either one, directly using the confidence of the various predictions as a weighting function. Another method is to use stacking to train a machine learning component that can optimally combine the two sets of predictions. Another method is to incorporate a machine learning component that takes both sets of data directly into account, for training and prediction purposes

### Generating Prediction/Recommendation Explanations

Explanation of Predictions—purchase timing recommendations based on price predictions or predictions on future model releases may be helpful to people when the quantitative prediction is accompanied by one or more intuitive explanations including explanations such as some or all of the following:
We are close to the average time between releases since the last release
A coupon or other promotion is about to start;
A coupon (or other promotion) is about to expire;
Supplies are running low of this product;
A positive/negative review has changed the demand for this product; and
The product is late/early in its life cycle.
The lowest priced seller has recently stopped selling the product temporarily
   There are different ways to generate these predictions, some of which are described below.

In conjunction with predictions and recommendations, some embodiments may generate association rules based on understandable factors that support the predictions that we make. Along with each prediction, one or more most confident association rules may be displayed to explain (at least in part) the predictions.

Another embodiment may generate explanations through the following method. For each possible attribute of a record, set that attribute to be “missing” before sending it into the classifier and then record the impact of the missing attribute on the probability of a price change. The result of this process is a list of attributes that affect the prediction ordered by their impact on our predictions. Most relevant attribute-value pairs can then be automatically translated into English explanations via a deterministic mapping.

In addition, some embodiments create association rules, or a simplified 1-level classifier for price drops, such as a logistic regression. Using the input example and classifier structure, the impact of an attribute on the final classification can be determined, which also corresponds with the prediction created by a primary classifier. For example, with logistic regression, this would be the weight associated with the attribute multiplied by the attribute value.

The problem of buying the “right” product at the best price is a complex one, due to the many components of price (including coupons, rebates, sales tax, etc.), the release of new models (particularly, for technology-based products including consumer electronics, software, and more), and price volatility over time. Various embodiments as disclosed herein are focused on the timing of purchase.

As described above, relevant data is gathered, stored, appropriately synthesized, and mined to provide predictions for the future (of prices and model releases) and/or recommendations to customers (or to be used internally for the purposes of buying a product and then re-selling it to customers). In addition, some embodiments generate explanations of the predictions and/or recommendations thus generated.

Based on these predictions the system can issue a recommendation to a customer (e.g., ‘buy’ versus ‘wait’), an explanation of its prediction (e.g., ‘wait’ because a new model is likely to come out in the next 30 days), a price prediction (e.g., prices are likely to drop by 10% or more in the next 14 days), and/or it can use its predictions as basis of buying/selling decisions. For example, the system can be utilized for “price arbitrage” where a merchant utilizes the predictions to buy (or sell) inventory at the current (or discounted) price based on its anticipation of how price will move in the future. When this anticipation is correct, on average, then this practice can be highly profitable. For example, suppose that a laptop sells currently for $2,500. The system anticipates that the price will drop to $2,000 within 14 days. The vendor can then offer the laptop (to be shipped within 14 days) for $2,250. This locks in a superior price for the customer today ($2,250), but enables the vendor to obtain extra profit margin if it buys the laptop at $2000, having collected $2,250 from the customer.

The description now turns to procedures that may be performed in accordance with at least one embodiment of the invention, for example, by one or more components of the prediction service 200 (FIG. 2).

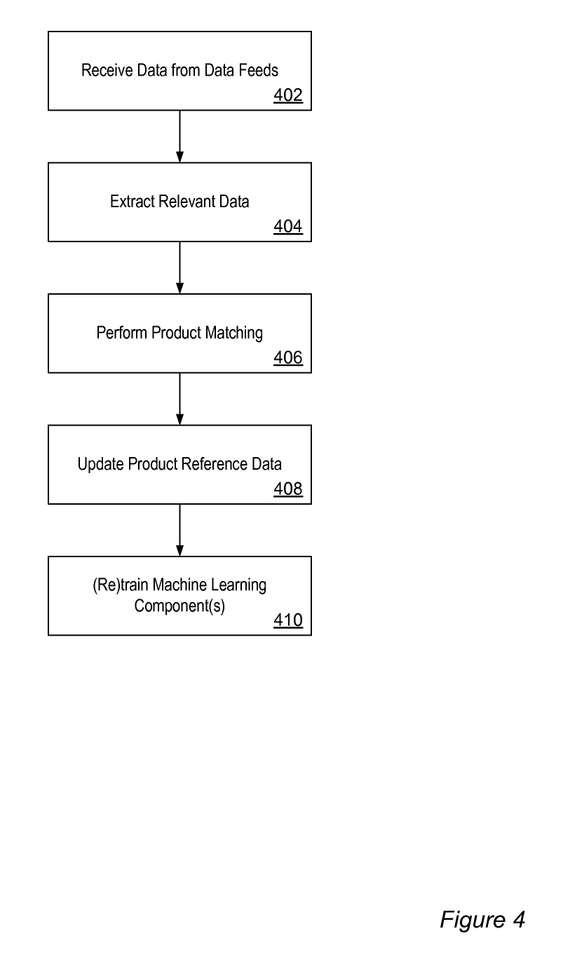

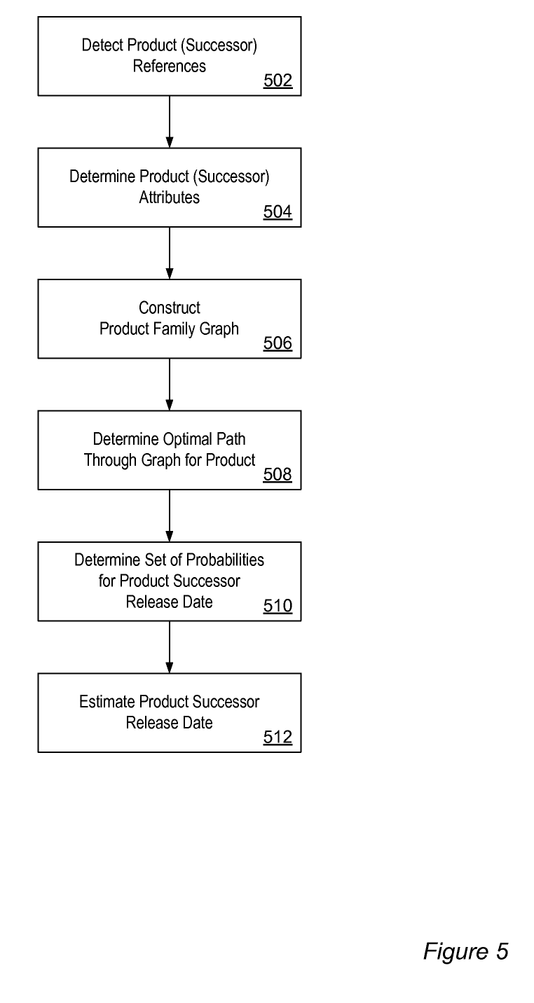

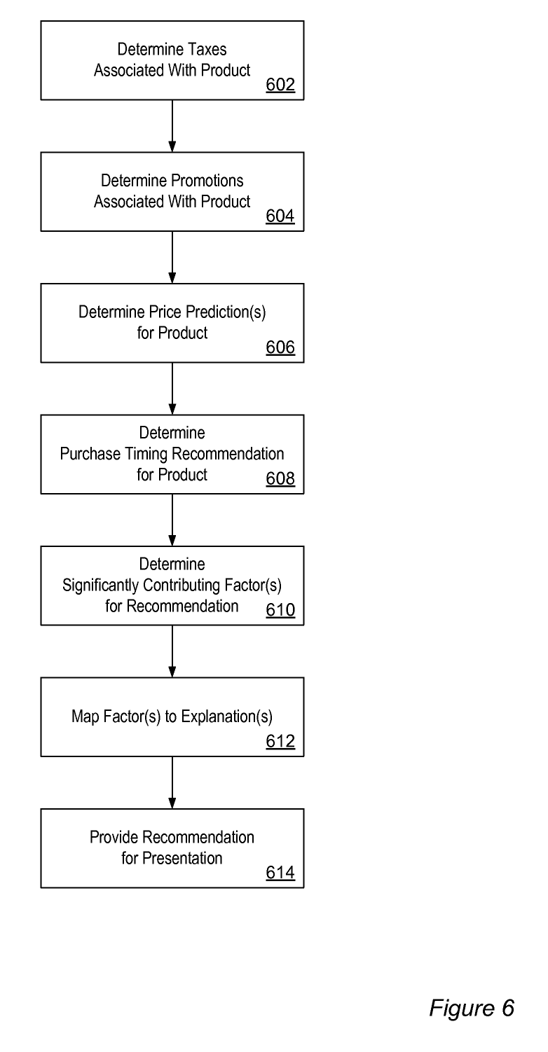

FIG. 4, FIG. 5 and FIG. 6 depict example steps for price and model prediction in accordance with at least one embodiment of the invention. Unless stated otherwise, or clearly contradicted by context, the steps depicted in FIG. 4, FIG. 5 and FIG. 6 may, occur asynchronously and/or in parallel. For example, various data structures, and/or versions thereof, may be updated at one step while being utilized at another step. Alternatively, or in addition, unless stated otherwise, or clearly contradicted by context, one or more of the steps depicted in FIG. 4, FIG. 5 and FIG. 6 may incorporate, and/or be incorporated by, one or more other of the steps depicted in FIG. 4, FIG. 5 and FIG. 6.

At step 402, new data including product data and prices may be collected (e.g., extracted at step 404) from a variety of data feeds including data feeds corresponding to and/or provided by a plurality of merchants. At step 406, product matching as described above may be utilized to associate collected data with reference data. At step 408, collected data may be combined with product reference data (e.g., stored in the product database 212 of FIG. 2). Updates to existing unique products or newly created unique products may be incorporated into the reference database. At step 410, matched product data and pricing data may be sent to the various machine learning components described above, and classifiers trained and/or retrained with the data.

At step 502, one or more references to a product and/or a product successor may be detected in text including free-form text. For example, one or more machine learning components may detect potential references and associate them with normalized product identifiers assigned by the product matching component 204 (FIG. 2). At step 504, one or more attributes of a product and/or a product successor may be detected and/or determined, for example, by a machine learning component or more basic information extraction component (e.g., a regular expression based parser). Various product attributes such as technical specifications may be extracted. The determined product attributes may be associated with the products identified at step 502 and stored in the product database 212. One or more potential successor product release dates may also be identified and extracted.

At step 506, a product family graph may be constructed. For example, the product lineage component 302 (FIG. 3) may construct the product family graph as described above based on information in the product database 212 (FIG. 2) and various configured constraints. At step 508, a path through the product family graph may be determined as a representation of the evolution of the product through time. At step 510, this product path may be sent to a classifier trained by a machine learning component to produce a set of probabilities for product successor release. At step 512, an estimated release date may be determined. For example, the estimated release date may be determined based on one or more prospective release dates extracted from text and/or the set of probabilities produced at step 510.

At step 602, taxes associated with a product may be determined, for example, by the tax component 310 (FIG. 3). Taxes associated with a product may be different for different merchants offering the product for sale. At step 604, promotions associated with the product may be determined, for example, by the promotions component 312. At step 606, one or more price predictions may be determined, for example, by the price prediction component 206 (FIG. 2). Price predictions may be based the tax and promotions information of steps 602 and 604, as well as pricing data. As described above, price predictions including price movement directions and price range estimates may be determined by one or more machine learning components.

At step 608, a purchase timing recommendation may be determined, for example, by the purchase timing recommendation component 304 (FIG. 3). Purchase timing recommendations may be determined based on the price prediction(s) of step 606 and the successor availability date predictions of step 510 and/or step 512. At step 610, one or more factors that significantly contributed to the recommendation of step 608 may be determined, for example, by the prediction explanation component 308, and the factor(s) may be mapped to human-readable explanation(s) at step 612. In accordance with at least one embodiment of the invention, step 612 may be incorporated into step 610. At step 614, the recommendation of step 608 and support information such as the explanation of step 610, may be provided for presentation, for example, with a suitable user interface 220 (FIG. 2).

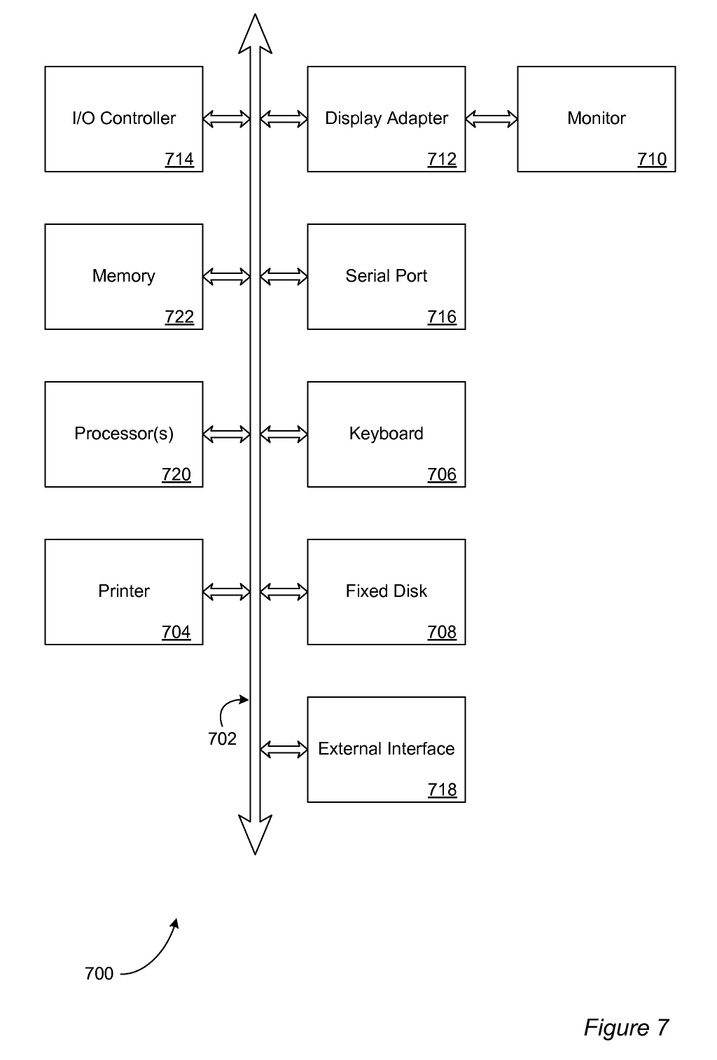

In accordance with at least some embodiments, the system, apparatus, methods, processes and/or operations for price and model prediction may be wholly or partially implemented in the form of a set of instructions executed by one or more programmed computer processors such as a central processing unit (CPU) or microprocessor. Such processors may be incorporated in an apparatus, server, client or other computing device operated by, or in communication with, other components of the system. As an example, FIG. 7 depicts aspects of elements that may be present in a computer device and/or system 700 configured to implement a method and/or process in accordance with some embodiments of the present invention. The subsystems shown in FIG. 7 are interconnected via a system bus 702. Additional subsystems such as a printer 704, a keyboard 706, a fixed disk 708, a monitor 710, which is coupled to a display adapter 712. Peripherals and input/output (I/O) devices, which couple to an I/O controller 714, can be connected to the computer system by any number of means known in the art, such as a serial port 716. For example, the serial port 716 or an external interface 718 can be utilized to connect the computer device 700 to further devices and/or systems not shown in FIG. 7 including a wide area network such as the Internet, a mouse input device, and/or a scanner. The interconnection via the system bus 702 allows one or more processors 720 to communicate with each subsystem and to control the execution of instructions that may be stored in a system memory 722 and/or the fixed disk 708, as well as the exchange of information between subsystems. The system memory 722 and/or the fixed disk 708 may embody a tangible computer-readable medium.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components, processes or functions described in this application may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments of the invention and does not pose a limitation to the scope of the invention unless otherwise claimed. No language in the specification should be construed as indicating any non-claimed element as essential to each embodiment of the present invention

Different arrangements of the components depicted in the drawings or described above, as well as components and steps not shown or described are possible. Similarly, some features and subcombinations are useful and may be employed without reference to other features and subcombinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

That which is claimed is:

1. A method for purchase timing guidance with respect to consumer products, the method comprising:
receiving data from at least one data feed, the received data including pricing information corresponding to at least one purchasable product and a plurality of merchants;
training at least one machine learning component, the training based at least in part on changes over time of a statistic of the pricing information corresponding to said at least one purchasable product and the plurality of merchants;
determining a purchase timing recommendation corresponding to the purchasable product with said at least one trained machine learning component; and
providing the purchase timing recommendation for presentation.

2. A method in accordance with claim 1, wherein the pricing information is received from said at least one data feed on a daily or more granular basis.

3. A method in accordance with claim 1, wherein:
said at least one purchasable product is differently identified by the plurality of merchants in the received data; and
the method further comprises matching the different identifications of said at least one purchasable product for machine learning component training and prediction purposes.

4. A method in accordance with claim 3, wherein the matching is based at least in part on UPC information provided by at least one of the plurality of merchants.

5. A method in accordance with claim 3, wherein the matching is based at least in part on MPN information provided by at least one of the plurality of merchants.

6. A method in accordance with claim 1, the method further comprising determining, with said at least one trained machine learning component, at least one prediction of a price of said at least one purchasable product.

7. A method in accordance with claim 3, wherein said at least one prediction of the price of said at least one purchasable product comprises a first prediction corresponding to a price rise and a second prediction corresponding to a price drop.

8. A method in accordance with claim 7, wherein the first and second predictions are determined with a regression type machine learning component.

9. A method in accordance with claim 3, wherein said at least one prediction of the price of said at least one purchasable product corresponds to a predicted lowest price offered by the plurality of merchants.

10. A method in accordance with claim 1, wherein the received data comprises free-form text and said at least one machine learning component is trained to identify the pricing information in the free-form text.

11. A method in accordance with claim 1, wherein said at least one data feed corresponds to a web site.

12. A method in accordance with claim 1, wherein the purchase timing recommendation is selected from a group consisting of (i) a recommendation to buy and (ii) a recommendation to wait.

13. A method in accordance with claim 1, wherein providing the purchase timing recommendation for presentation comprises providing a representation of the purchase timing recommendation including a price movement direction indicator corresponding to one of: (i) an indication that the price of the purchasable product is likely to increase, (ii) an indication that the price of the purchasable product is likely to decrease, and (iii) an indication that the price of the purchasable product is like to remain relatively steady.

14. A method in accordance with claim 13, wherein said at least one machine learning component comprises:
a first machine learning component trained at least to predict whether the price of the purchasable product will increase and remain above one or more upper price thresholds during a time interval;
a second machine learning component trained at least to predict whether the price of the purchasable product will decrease and remain below one or more lower price thresholds during the time interval; and
a third machine learning component trained at least to predict whether the price of the purchasable product will remain between said one or more upper price thresholds and the one or more lower price thresholds during the time interval.

15. A method in accordance with claim 14, wherein the first, second and third machine learning components are random forest type machine learning components.

16. A method in accordance with claim 14, wherein the first, second and third machine learning components are boosting type machine learning components.

17. A method for purchase timing guidance, the method comprising:
training at least one machine learning component to detect, in free-form text, information relating to purchasable products and successors of purchasable products;
receiving free-form text from at least one data feed;
determining, with said at least one trained machine learning component, that the received free-form text includes information relating to a purchasable product or a successor of the purchasable product;
extracting the information relating to the purchasable product or the successor of the purchasable product to a structured representation; and
providing for presentation information based at least in part on the structured representation.

18. A method in accordance with claim 17, wherein determining that the received free-form text includes information relating to the purchasable product comprises matching information identifying the purchasable product in the free-form text to a different identification of the purchasable product.

19. A method in accordance with claim 18, wherein the information identifying the purchasable product comprises a category of the purchasable product.

20. A method in accordance with claim 17, wherein extracting the information comprises extracting the information with said at least one trained machine learning component.

21. A method in accordance with claim 17, the method further comprising:
determining that the free-form text relates to availability of the successor of the purchasable product during at least one time interval; and
determining a purchase timing recommendation corresponding to the purchasable product based at least in part on the availability of the successor of the purchasable product during said at least one time interval.

22. A method in accordance with claim 21, wherein determining that the free-form text relates to availability comprises determining that the free-form text relates to availability with said at least one trained machine learning component.

23. A method in accordance with claim 21, wherein determining the purchase timing recommendation comprises determining the purchase timing recommendation with said at least one trained machine learning component.

24. A method for purchase timing guidance, the method comprising:
receiving free-form text from at least one data feed;
determining, with at least one machine learning component, that the free-form text relates to availability of a successor of a product during at least one time interval;
determining at least one prediction based at least in part on information extracted from the free-form text relating to the availability of the successor of the product during said at least one time interval; and
providing a representation of said at least one prediction for presentation.

25. A method in accordance with claim 24, wherein determining said at least one prediction comprises determining a probability distribution with respect to dates corresponding to said at least one time interval.

26. A method in accordance with claim 25, wherein the probability distribution is determined with at least one supervised machine learning component.

27. A method in accordance with claim 24, wherein said at least one prediction is determined based further at least in part on a product lineage that references the product, one or more ancestors of the product, and zero or more descendants of the product.

28. A method in accordance with claim 27, wherein determining the product lineage comprises:
generating a graph of family relationships between products based at least in part on product attributes; and
determining an optimal path through the graph of family relationships in accordance with a ranking function.

29. A method in accordance with claim 28, wherein the product attributes include at least one numerical value quantifying a technical capability of a plurality of the products.

30. A method in accordance with claim 24, wherein determining that the free-form text relates to availability of a successor of the product comprises matching information identifying the product in the free-form text to a different identification of the product.

31. A method in accordance with claim 24, the method further comprising:
determining at least one significant factor contributing to said at least one prediction; and
providing for presentation at least one human-readable explanation for said at least one prediction corresponding to said at least one significant factor.
